(19) United States
(12) Patent Application Publication
(10) Pub. No.: US 2004/0141655 A1
(43) Pub. Date: Jul. 22, 2004

(54) Method and apparatus for image processing

(75) Inventor: Takeshi Aoyagi, Tokyo (JP)

Correspondence Address: FITZPATRICK CELLA HARPER & SCINTO, 30 ROCKEFELLER PLAZA, NEW YORK, NY, 10112, US

(73) Assignee: CANON KABUSHIKI KAISHA, Tokyo (JP)

(21) Appl. No.: 10/754,526

(22) Filed: Jan. 12, 2004

(30) Foreign Application Priority Data
Jan. 15, 2003 (JP) 2003-007664

(51) Int. Cl. G06K 9/36

(52) U.S. Cl. 382/239

(57) ABSTRACT

This disclosure relates to a technique of coding image data such that the data amount of the coded data falls within a predetermined amount, and decoding the coded image data. When, for example, image data is to be JPEG-compressed, the data amount of the coded data is obtained, and it is determined whether the data amount exceeds the capacity of a memory. If it is determined that the data amount exceeds the capacity of the memory, the compression ratio is increased, and the image data is compressed. In addition, the number of times it was determined that the data amount exceeded the capacity of the memory is counted. In decoding the data, the count value is obtained, and a quantization table is set in accordance with the count value, thereby decoding the data stored in the memory.

### FIELD OF THE INVENTION

The present invention relates to a method and apparatus for image processing and, more particularly, to a technique of coding image data such that the data amount of the coded data falls within a predetermined amount, and decoding the coded image data.

### BACKGROUND OF THE INVENTION

Recently, in an image processing system which has a scanner, printer, and the like, and processes the image data input from the scanner to print the data by using the printer, the image read by the scanner can be transmitted on a local area network (LAN) or the Internet, and the image received from the LAN or the Internet can be printed by the printer. In addition, it becomes necessary to exchange various image data using networks. For example, it becomes necessary to fax the image read by the scanner or receive data from a communication line by using a modem to print it using the printer.

For example, in such an image processing system, data exchange occurs to convert PDL data, input image data from the scanner, image data for printer output operation, FAX image data, and data to be stored in an image database server into various formats or to input/output the respective data.

In consideration of processing performance in this image processing system, exchanging large-volume data is a large negative factor in a situation wherein image data are frequently exchanged. The image data input from a scanner, in particular, greatly increases in data amount because of the number of colors for expressing colors, the number of bits for expressing gray levels, an increase in resolution with an improvement in image quality, and the like.

In general, therefore, when the image data input from a scanner is to be handled in an image processing system, the data is compressed to reduce its data amount, and the compressed data is temporarily stored in a memory before it is processed. Various data compression methods are available for such data compression. For example, JPEG (Joint Photographic Experts Group) compression is known. JPEG compression allows data compression in accordance with the features of each image data input from the scanner. JPEG is generally used as a compression method suitable for grayscale images.

The capacity of a memory which stores image data compressed by such a technique is determined on the assumption that compressed image data is stored. In JPEG compression, the compression ratio changes depending on the contents of original image data, and hence data is not always compressed at a predicted compression ratio. If image data is compressed at a compression ratio lower than a predictive compression ratio, the data amount of the compressed image data exceeds the predicted data amount. For this reason, the compressed data exceeds the memory capacity of a memory which stores the data, and cannot be completely stored in the memory. In such a case, the predictive compression ratio is increased, and compression must be executed again. That is, an original must be repeatedly set and scanned until the image data is compressed at a compression ratio that makes the data amount fall within the capacity of the memory. This operation is cumbersome for the user.

In order to solve this problem, a method is conceivable, which compresses input data through a plurality of compression routes with different predictive compression ratios, and stores coded data processed at a lower compression ratio in a main memory while storing coded data processed at a higher compression ratio in a temporary memory. In this method, if data exceeding the capacity of the main memory is input, the data in the main memory is cleared, and the data coded at the higher compression ratio and stored in the temporary memory is input in real time.

In order to compress such data so as to store it in the main memory, a plurality of quantization tables (Q tables) must be prepared. This increases the memory capacity for the storage of quantization tables. When data is decoded, the same quantization tables as those used for coding operation must be used. Therefore, a plurality of quantization tables are required for a portion which performs decoding. This leads to an increase in memory capacity for the storage of quantization tables.

### SUMMARY OF THE INVENTION

The present invention has been proposed to solve the conventional problems and it provides a technique of preventing an increase in the capacity of a memory for storing quantization tables used for coding and decoding, storing image data coded to have a suitable amount in the memory, and decoding the data.

An image processing apparatus according to the present invention comprises a compression unit which compresses image data, a data amount calculation unit which obtains a data amount of the image data compressed by the compression unit, a determination unit which determines whether the data amount calculated by the data amount calculation unit exceeds a capacity of a memory, a control unit which performs control to increase a compression ratio of the compression unit in accordance with a determination result obtained by the determination unit, make the compression unit compress the image data, and store the image data in the memory, a counting unit which counts the number of times the determination unit determined that the data amount exceeded the capacity of the memory, and a decoding unit which decodes the data stored in the memory on the basis of a count value of the counting unit.

Other features and advantages of the present invention will be apparent from the following description taken in conjunction with the accompanying drawings, in which like reference characters designate the same or similar parts throughout the figures thereof.

### BRIEF DESCRIPTION OF THE DRAWINGS

The accompanying drawings, which are incorporated in and constitute a part of the specification, illustrate embodiments of the invention and, together with the description, serve to explain the principles of the invention.

FIGS. 1A and 1B are block diagrams showing the overall arrangement of an image processing system according to an embodiment of the present invention;

FIG. 2 is a view showing the detailed arrangement of packet data according to this embodiment;

FIG. 3 is a view showing the detailed internal arrangement of a packet table according to this embodiment;

FIG. 4 is a view showing a method of dividing image data on a tile basis;

FIG. 5 is a view schematically showing the arrangement of packet data according to this embodiment;

FIGS. 6 to 15 are block diagrams for briefly describing a method of storing packet data in a memory according to this embodiment;

FIG. 16 is a block diagram showing an arrangement for general JPEG compression;

FIG. 17 is a block diagram showing the detailed internal arrangement of a predictive coding unit in JPEG compression;

FIG. 18 is a view for explaining zigzag scanning in JPEG compression;

FIG. 19 is a view for explaining Huffman coding in JPEG compression;

FIG. 20 is a block diagram showing an arrangement for general JPEG decoding;

FIG. 21 is a block diagram showing the arrangement of blocks to explain the effect of bit shifting of quantized data in performing JPEG compression;

FIG. 22 is a view showing the result obtained by Huffman-coding quantized data without bit shifting to explain the effect of bit shifting of quantized data in performing JPEG compression;

FIG. 23 is a view showing the result obtained by Huffman-coding quantized data with 1-bit shifting to explain the effect of bit shifting of quantized data in performing JPEG compression;

FIG. 24 is a block diagram showing the arrangement of a JPEG compression unit in the image processing system according to this embodiment;

FIGS. 25 to 32 are block diagrams schematically showing a method of storing JPEG-compressed data in the memory according to this embodiment;

FIG. 33 is a block diagram showing the detailed arrangement of a tile compression unit according to this embodiment;

FIG. 34 is a block diagram showing the detailed arrangement of a RAM controller according to this embodiment;

FIG. 35 is a block diagram showing the detailed arrangement of a tile decompression unit according to this embodiment;

FIG. 36 is a flow chart for explaining processing in the image processing system according to this embodiment;

FIG. 37 is a block diagram showing the detailed arrangement of a tile compression unit according to the second embodiment of the present invention;

FIG. 38 is a block diagram showing the detailed arrangement of a RAM controller according to the second embodiment;

FIG. 39 is a block diagram showing the detailed arrangement of a JPEG decompression unit of a tile decompression unit according to the second embodiment of the present invention;

FIG. 40 is a block diagram for explaining in detail processing in a tile compression unit according to the third embodiment of the present invention; and

FIG. 41 is a view showing the detailed arrangement of packet data according to the third embodiment of the present invention.

### DETAILED DESCRIPTION OF THE PREFERRED EMBODIMENTS

Preferred embodiments of the present invention will now be described in detail in accordance with the accompanying drawings.

[First Embodiment]

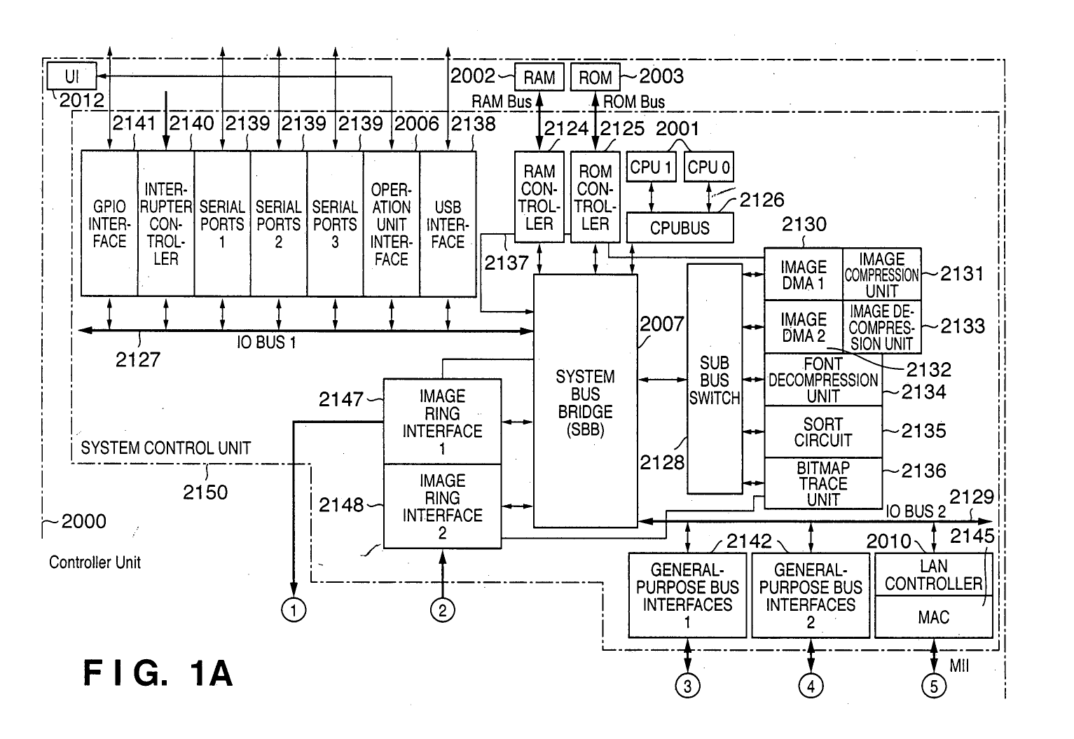

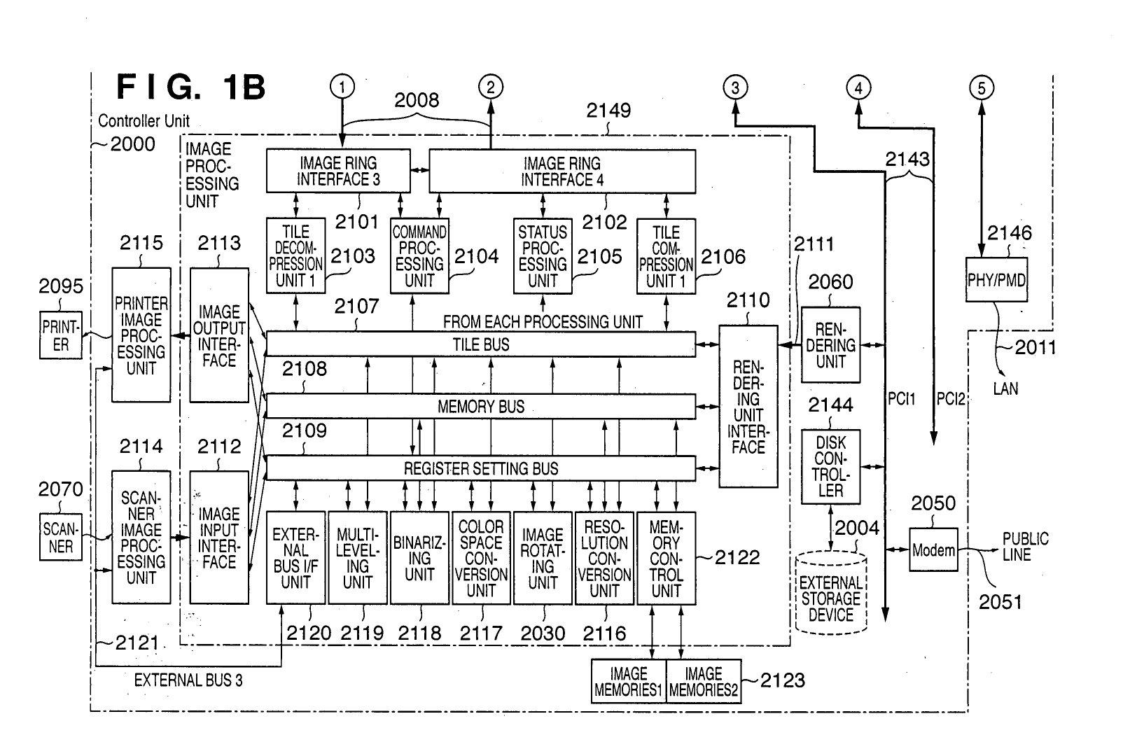

FIGS. 1A and 1B are block diagrams showing the overall arrangement of an image processing system according to an embodiment of the present invention.

Referring to FIGS. 1A and 1B, a controller unit 2000 is connected to a scanner 2070 serving as an image input device and a printer 2095 serving as an image output device, and is also connected to a LAN 2011 and a public line (WAN) 2051 to input/output image information and device information and bitmap PDL data into image data. CPUs 2001 installed in a system control unit 2150 are processors which control the overall system. This embodiment exemplifies the use of two CPUs. These two CPUs are commonly connected to a CPU bus 2126, and are also connected to a system bus bridge 2007. The system bus bridge 2007 is a bus switch, to which the following are connected: the CPU bus 2126, a RAM controller 2124, a ROM controller 2125, an I/O bus 1 (2127), a sub bus switch 2128, an I/O bus 2 (2129), an image ring interface 1 (2147), an image ring interface 2 (2148), and the like. The sub bus switch 2128 is the second bus switch, to which an image DMA 1 (2130), image DAM 2 (2132), font decompression unit 2134, sort circuit 2135, and bitmap trace unit 2136 are connected. This bus switch arbitrates on memory access requests output from these DMAs to make connections to the system bus bridge 2007.

A RAM 2002 is a system work memory which temporarily stores programs and various data when the CPU 2001 operates, and also serves as an image memory for temporarily storing image data. Access to the RAM 2002 is controlled by the RAM controller 2124. This embodiment uses a direct RDRAM. A ROM 2003 is a boot ROM, in which a boot program for this system is stored. Read access to the ROM 2003 is controlled by the ROM controller 2125.

The image DMA 1 (2130) is connected to an image compression unit 2131 to control the image compression unit 2131 on the basis of the information set through a register access ring 2137 so as to read out non-compressed data stored in the RAM 2002, compress the data, and write back the compressed data. This embodiment exemplifies the use of JPEG as a compression algorithm. The image DAM 2 (2132) is connected to an image decompression unit 2133 to control the image decompression unit 2133 on the basis of the information set through the register access ring 2137 so as to read out compressed data stored in the RAM 2002, decompress the data, and write back the decompressed data. This embodiment exemplifies the use of JPEG as a decompression algorithm.

The font decompression unit 2134 decompresses the compressed font data stored in the ROM 2003 or RAM 2002 using a known FBE (First Binary Encoding) technique on the basis of the font code contained in PDL data externally transmitted through a LAN controller 2010 or the like. The sort circuit 2135 is a circuit which rearranges the order of the objects of a display list created when the PDL data is bitmapped. The bitmap trace unit 2136 is a circuit which extracts edge information from bitmapped data. The I/O bus 1 (2127) is a kind of internal I/O bus, to which a controller for a USB bus as a standard bus, a USB interface 2138, a general-purpose serial port 2139, an interrupter controller 2140, and a GPIO interface 2141 are connected. The I/O bus 1 includes a bus arbiter (not shown).

An operation unit I/F 2006 includes an operation unit (UI) 2012 and interface unit, and outputs, to the operation unit 2012, image data to be displayed on the operation unit 2012. The operation unit I/F 2006 also serves to transmit, to the CPU 2001, information input by the user of the system according to this embodiment by using the operation unit 2012. The I/O bus 2 (2129) is a kind of internal I/O bus, to which general-purpose bus interfaces 1 and 2 (2142) and the LAN controller 2010 are connected. The I/O bus 2 includes a bus arbiter (not shown). The general-purpose bus interface 2142 is a bus bridge which includes two identical bus interfaces and supports a standard I/O bus. This embodiment exemplifies the use of PCI buses 2143.

An external storage device 2004 stores system software, image data, and the like. In this embodiment, a hard disk drive is used as the external storage device 2004, which is connected to one of the PCI buses 2143 through a disk controller 2144. The LAN controller 2010 is connected to the LAN 2011 through a MAC circuit 2145 and PHY/PMD (Physical Layer Protocol/Physical Layer Medium Dependent) circuit 2146 to input/output information through the LAN 2011. A modem 2050 is connected to the public line 2051.

An image ring interface 1 (2147) and image ring interface 2 (2148) serve as a DMA controller which connects the system bus bridge 2007 to an image ring 2008 which transfers image data at high speed, and transfers data which has been compressed after tiling between the RAM 2002 and a tile image processing unit 2149. The image ring 2008 is constituted by a pair of unidirectional connection paths (image rings 1 and 2). The image ring 2008 is connected to a tile decompression unit 2103, command processing unit 2104, status processing unit 2105, and tile compression unit 2106 through an image ring interface 3 (2101) and image ring interface 4 (2102) in the tile image processing unit 2149. This embodiment exemplifies the implementation of two tile decompression units 2103 and three tile compression units 2106.

The tile decompression unit 2103 is connected to a tile bus 2107, in addition to the above image ring interfaces, to decompress compressed image data input from the image ring 2008 and transfer the decompressed data to the tile bus 2107. This embodiment uses JPEG for decompression of multilevel data, and the PackBits decompression algorithm for binary data. The tile compression unit 2106 is connected to the tile bus 2107, in addition to the image ring interface, to compress image data before compression, which is input from the tile bus 2107, and transfer the data to the image ring 2008. This embodiment uses JPEG for compression of multilevel data, and the PackBits compression algorithm for compression of binary data.

The command processing unit 2104 is connected to a register setting bus 2109, in addition to the image ring interface, to write a register setting request, which is issued by the CPU 2001 and input through the image ring 2008, in the corresponding block connected to the register setting bus 2109. In addition, in accordance with a register readout request issued by the CPU 2001, the command processing unit 2104 reads out information from the corresponding register through the register setting bus and transfers the information to the image ring interface 4 (2102). The status processing unit 2105 monitors information in each image processing unit, creates an interrupt packet for issuing an interrupt to the CPU 2001, and outputs it to the image ring interface 4 (2102).

In addition to the above blocks, the following functional blocks are connected to the tile bus 2107: a rendering unit interface 2110, image input interface 2112, image output interface 2113, multileveling unit 2119, binarizing unit 2118, color space conversion unit 2117, image rotating unit 2030, resolution conversion unit 2116, and the like. The rendering unit interface 2110 is an interface which receives the bitmapped image created by a rendering unit 2060 (to be described later). The rendering unit 2060 and rendering unit interface 2110 are connected to each other through a general video signal 2111. The rendering unit interface 2110 has connections to a memory bus 2108 and the register setting bus 2109 as well as the tile bus 2107. The rendering unit interface 2110 renders an input raster image into a tile image by a predetermined method set through the register setting bus, and at the same time, and synchronizes clocks to output the image to the tile bus 2107. The image input interface 2112 receives raster image data having undergone correction image processing in a scanner image processing unit 2114 (to be described later), renders the image into a tile image by a predetermined method set through the register setting bus, and synchronizes clocks to output the image to the tile bus 2107. The image output interface 2113 receives tile image data from the tile bus 2107, renders the image into a raster image, and changes the clock rate to output the raster image to a printer image processing unit 2115. The image rotating unit 2030 rotates image data. The resolution conversion unit 2116 changes the resolution of an image. The color space conversion unit 21 converts the color spaces of color and grayscale images. The binarizing unit 2118 binarizes a multilevel (color/grayscale) image. The multileveling unit 2119 converts a binary image into multilevel data.

An external bus interface unit 2120 is a bus bridge which converts/outputs, to an external bus 3 (2121), the write and read requests issued by the CPU 2001 and input through the image ring interfaces 1, 2, 3, and 4, command processing unit 2104, and register setting bus 2109. In this embodiment, the external bus 3 (2121) is connected to the printer image processing unit 2115 and scanner image processing unit 2114.

A memory control unit 2122 is connected to the memory bus 2108. The memory control unit 2122 writes and reads out image data in and from image memories 1 and 2 (2123) by predetermined address segmentation in accordance with requests from the respective image processing units, and also performs operation such as refreshing as needed. This embodiment exemplifies the use of an SDRAM as an image memory. The scanner image processing unit 2114 corrects the image data read by a scanner 2070 serving as an image input device. The printer image processing unit 2115 performs correction processing for printer output operation, and outputs the result to the printer 2095. The rendering unit 2060 bitmaps a PDL code or intermediate display list.

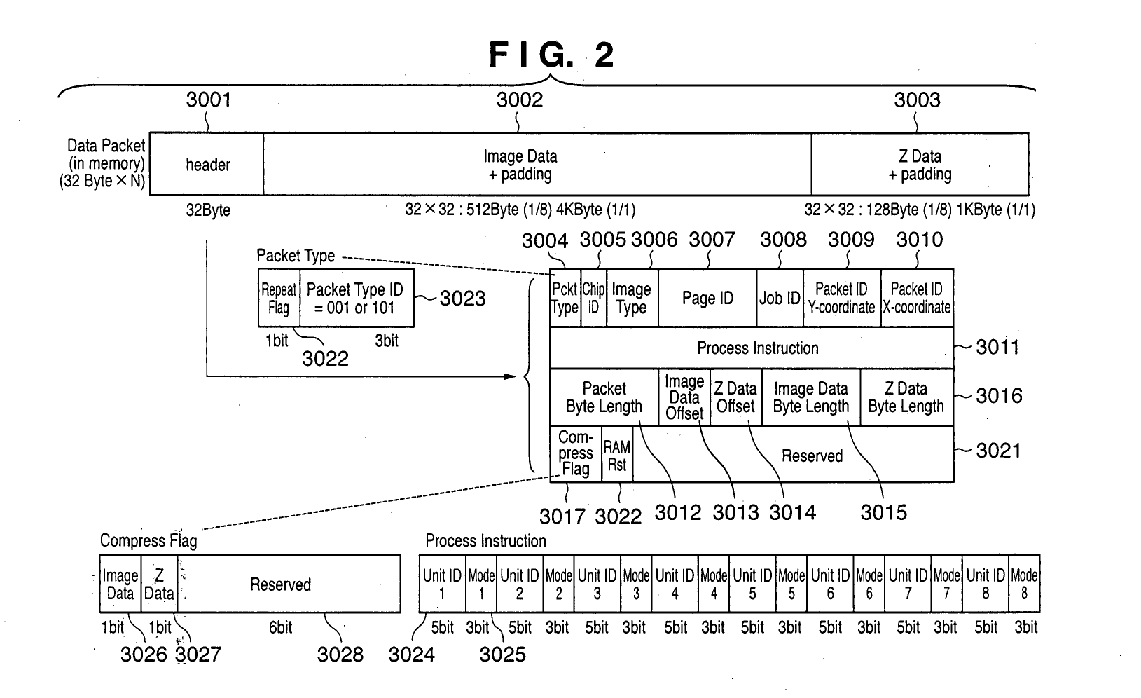

Assume that the controller unit 2000 according to this embodiment transfers image data in a packet form like the data packet shown in FIG. 2.

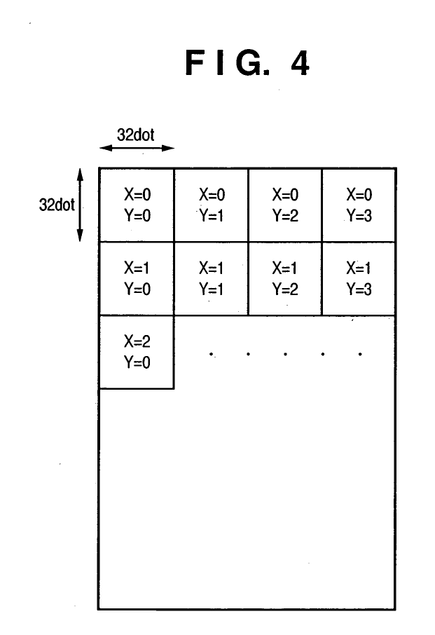

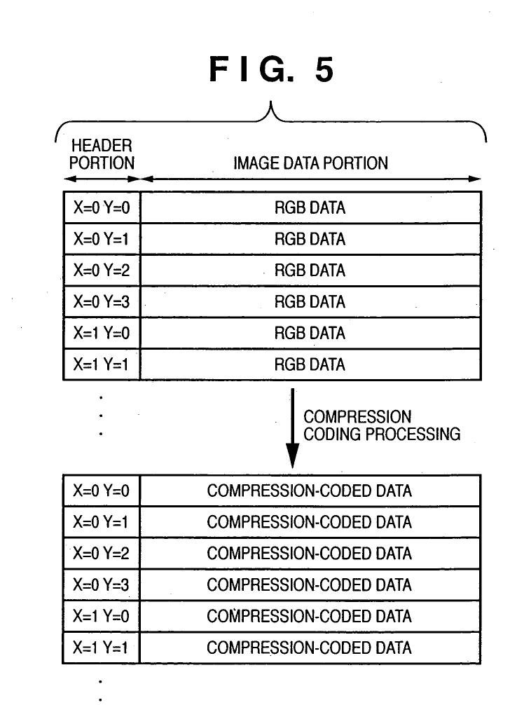

This embodiment exemplifies a case wherein image data is processed after it is divided into image data 3002 in a tile form which is constituted by 32 pixels×32 pixels as shown in FIG. 4. One data packet is formed by adding necessary header information 3001 and additional information (Z data and the like) and the like 3003 to image data on a tile basis. Note that as shown in FIG. 5, when image data is input from the scanner 2070, RGB data are set in the image data portion, whereas when the RGB data are compressed, the coded data after compression are set in the image data portion.

Information contained in header information 3001 in FIG. 2 will be described below. The type of a packet is identified by Pckt Type 3004 of the header information 3001. Pckt Type 3004 includes Repeat Flag 3022. When the image data of a data packet is identical to that of the immediately preceding data packet, this repeat flag is set. Chip ID 3005 indicates the ID of a chip as a target for packet transmission. Data Type 3006 indicates the type of data. Page ID 3007 indicates a page. Job ID 3008 is used to store a job ID to be managed by software.

A tile number is represented by (Yn, Xn), which is a combination of Packet ID Y-coordinate 3009 and Packet ID X-coordinate 3010. A data packet contains either compressed image data or non-compressed image data. This embodiment exemplifies the use of JPEG as a compression algorithm for multilevel color data (including multilevel grayscale data), and PackBits for binary data. Compress Flag 3017 is used to discriminate compressed image data from non-compressed image data. Assume that for Compress Flag 3017, 1 bit (3026) for image data and 1 bit (3027) for Z data are prepared, and “1” is set when compressed data is input as packet data.

Process instruction 3011 is left-aligned in processing order, and each process unit shifts a process instruction to the left by 8 bits after the completion of processing. In Process instruction 3011, eight pairs of Unit ID 3024 and Mode 3025 are stored. Unit ID 3024 designates each process unit. Mode 3025 designates an operation mode for each process unit. With this setting, one packet is continuously processed by eight units. Packet Byte Length 3012 indicates the total number of bytes of the packet. Image Data Byte Length 3015 indicates the number of bytes of image data. Z Data Byte Length 3016 indicates the number of bytes of image additional information. Image Data Offset 3013 and Z data Offset 3014 respectively indicate offsets of the respective data from the start of the packet.

RAM Rst 3022 is a memory set flag for transferring a signal for clearing the RAM 2002. This flag is fixed to “0” in normal processing. When the amount of data compressed by the tile compression unit 2106 exceeds the capacity of the RAM 2002, “1” is set in the flag. Upon receiving packet data with “1” in RAM Rst 3022, the RAM controller 2124 resets the RAM 2002 and a packet table (to be described later) on the basis of the received data. Note that reference numerals 3021 and 3028 denote reserved areas.

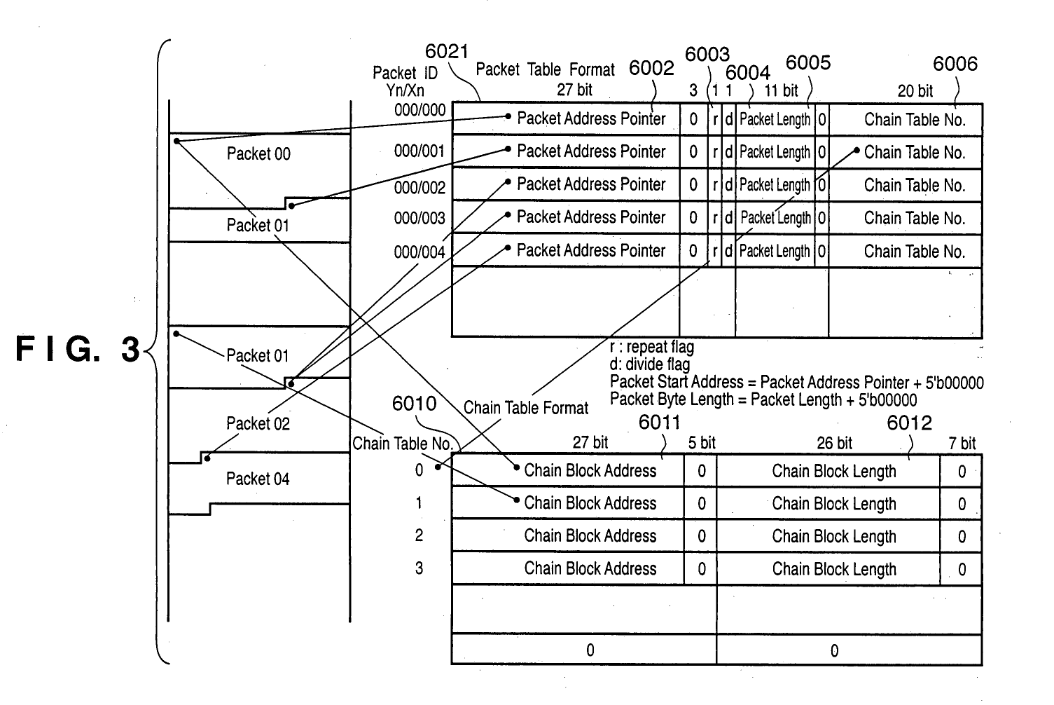

Each packet data is managed by a Packet Table 6001. FIG. 3 shows the constituent elements of the Packet Table 6001. When “0”s of five bits are added the respective table values, Packet Start Address 6002 and Packet Byte Length 6005 are obtained:

packet address pointer (27 bits)+“5b00000”=packet start address

packet length (11 bits)+“5b000000”=packet byte length

Assume that Packet Table 6001 and Chain Table 6010 are not separated.

In Packet Table 6001, packet address pointers are always arranged in the scanning direction in the order of Yn/Xn=000/000,000/001, 000/002, . . . . Each entry of Packet Table 6001 uniquely indicates one title. In addition, (Yn+1/X0) is the next entry to Yn/Xmax.

If a given packet is identical to the immediately preceding packet, the given packet is not written in the memory, and the same packet address pointer and packet length as those of the first packet are stored in the corresponding entry of the packet table. That is, one packet data is indicated by two table entries. In this case, Repeat Flag 6003 in the second table entry is set.

If a packet is divided into a plurality of portions by the chain DMA, Divide Flag 6004 is set, and Chain Table No. 6006 in the chain block in which the start portion of the packet is stored is set. Each entry of Chain Table 6010 includes Chain Block Address 6011 and Chain Block Length 6012, and “0”s are stored as an address and data length in the last entry of the table.

Processing based on such a packet form is characterized as follows.

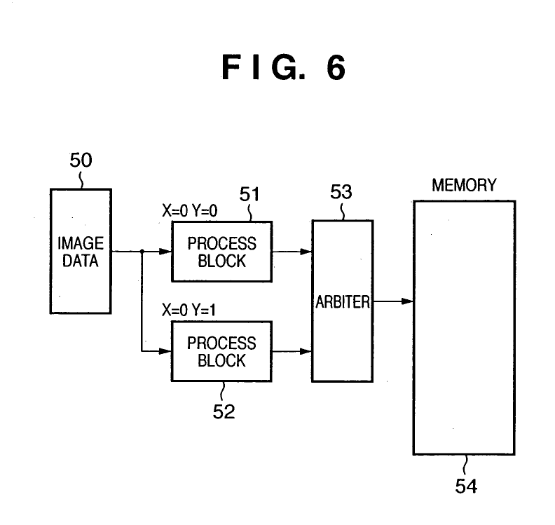

As shown in FIG. 6, consider an image processing system which tiles one image data 50, processes each packet with a header by using two process blocks 51 and 52, and stores the processing result in a memory 54 through an arbiter 53. In this case, until the transfer of the previously input packet format data is complete, the arbiter 53 stores the data input next. The arbiter 53 outputs the next data that has been stored immediately after the previously input data is completely output to the memory 54, thereby sequentially inputting data to the memory 54 for each packet format block in this order.

In the system shown in FIG. 6, each packet data is input to one of the process blocks 51 and 52 which has finished processing the previous tile data. Assume that in this embodiment, the processing time in the process block 51 is shorter than that in the process block 52.

FIGS. 6 to 15 are views showing a case wherein the image processing system according to this embodiment packets image data like that shown in FIG. 4 and processes the packet data.

Referring to FIG. 6, first of all, packet data with coordinates X=0 and Y=0 is input to the process block 51; and packet data with coordinates X=0 and Y=1, to the process block 52.

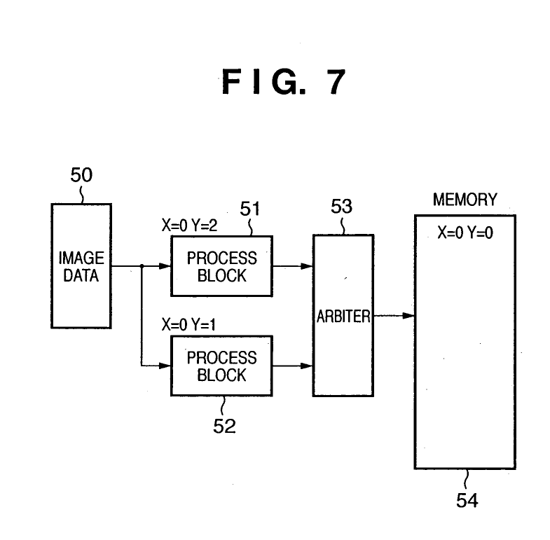

Referring to FIG. 7, the processing of the packet data with coordinates X=0 and Y=0 in the process block 51 is complete, and the processed data is stored at address 00 in the memory 54 through the arbiter 53. Next packet data with coordinates X=0 and Y=2 is newly input to the process block 51. At this time, the process block 52 is processing the packet data with coordinates X=0 and Y=1.

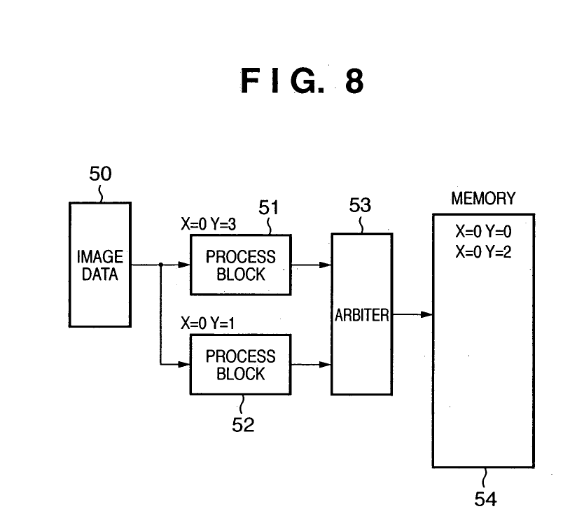

Referring to FIG. 8, the processing of the packet data with coordinates X=0 and Y=2 in the process block 51 is complete, and the processed data is stored at address 01 in the memory 54 through the arbiter 53. Next packet data with coordinates X=0 and Y=3 is newly input to the process block 51. At this time, the process block 52 is processing the packet data with coordinates X=0 and Y=1.

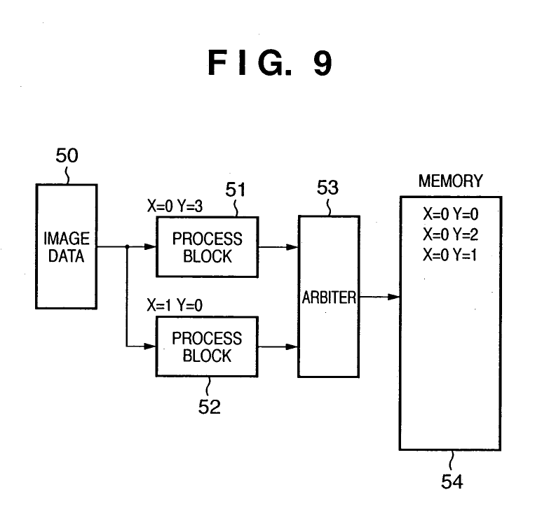

Referring to FIG. 9, the processing of the packet data with coordinates X=0 and Y=1 in the process block 52 is complete, and the processed data is stored at address 02 in the memory 54 through the arbiter 53. Next packet data with coordinates X=1 and Y=0 is newly input to the process block 52. At this time, the process block 51 is processing the packet data with coordinates X=0 and Y=3.

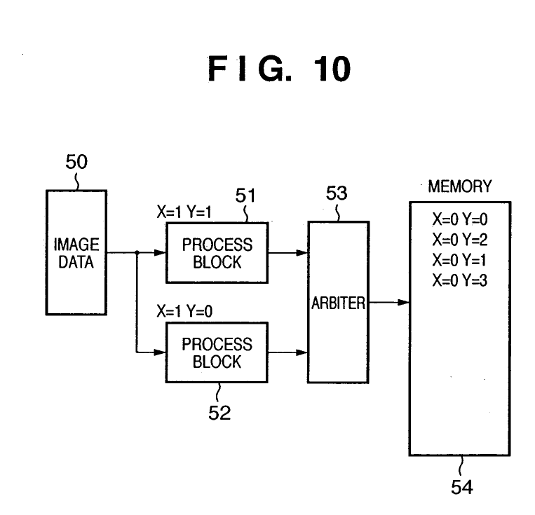

Referring to FIG. 10, the processing of the packet data with coordinates X=0 and Y=3 in the process block 52 is complete, and the processed data is stored at address 03 in the memory 54 through the arbiter 53. Next packet data with coordinates X=1 and Y=1 is newly input to the process block 51. At this time, the process block 52 is processing the packet data with coordinates X=1 and Y=0.

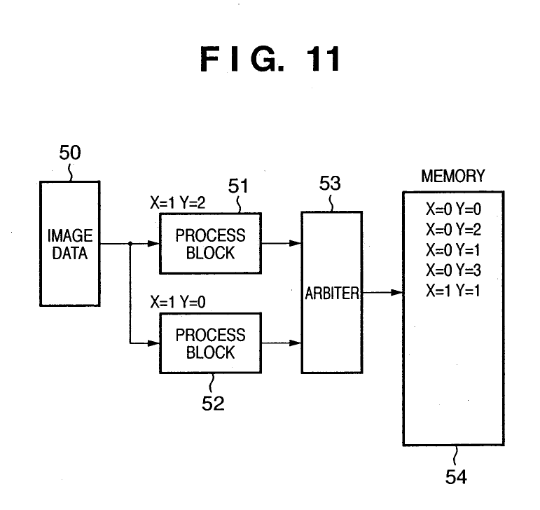

Referring to FIG. 11, the processing of the packet data with coordinates X=1 and Y=1 in the process block 51 is complete, and the processed data is stored at address 04 in the memory 54 through the arbiter 53. Next packet data with coordinates X=1 and Y=2 is newly input to the process block 51. At this time, the process block 52 is processing the packet data with coordinates X=1 and Y=0.

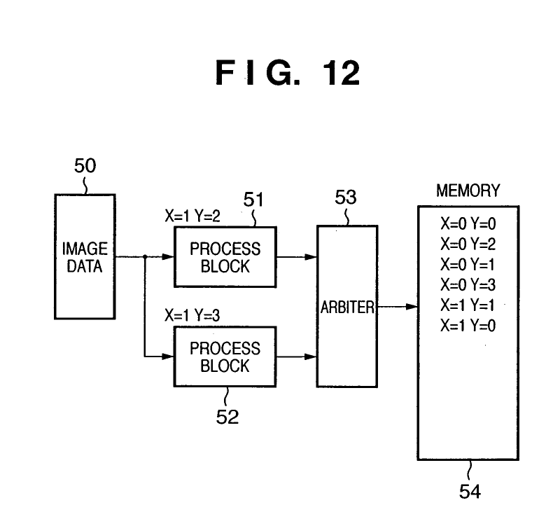

Referring to FIG. 12, the processing of the packet data with coordinates X=1 and Y=0 in the process block 52 is complete, and the processed data is stored at address 05 in the memory 54 through the arbiter 53. Next packet data with coordinates X=1 and Y=3 is newly input to the process block 52. At this time, the process block 51 is processing the packet data with coordinates X=1 and Y=2.

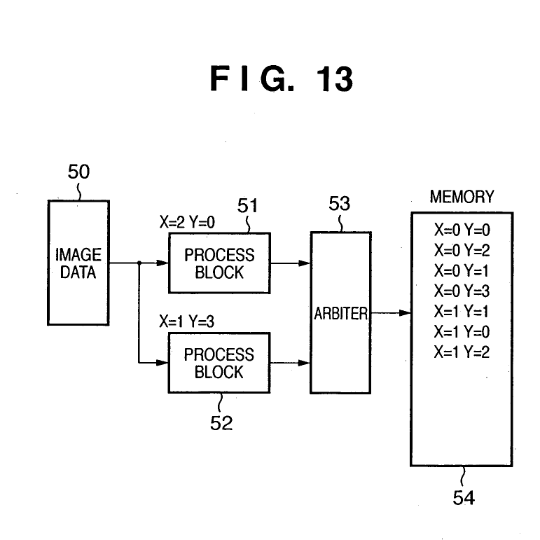

Referring to FIG. 13, the processing of the packet data with coordinates X=1 and Y=2 in the process block 51 is complete, and the processed data is stored at address 06 in the memory 54 through the arbiter 53. Next packet data with coordinates X=2 and Y=0 is newly input to the process block 51. At this time, the process block 52 is processing the packet data with coordinates X=1 and Y=3.

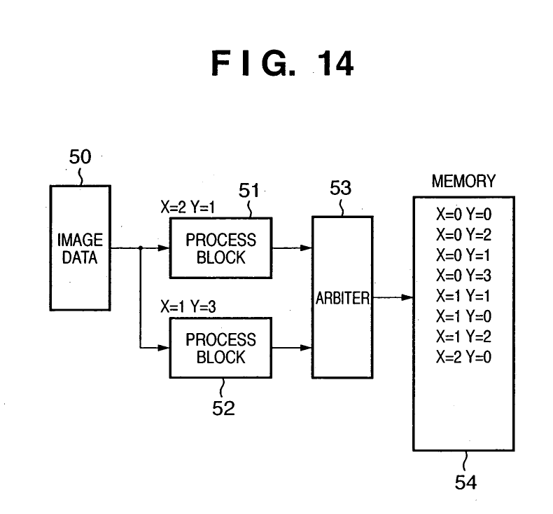

Referring to FIG. 14, the processing of the packet data with coordinates X=2 and Y=0 in the process block 51 is complete, and the processed data is stored at address 07 in the memory 54 through the arbiter 53. Next packet data with coordinates X=2 and Y=1 is newly input to the process block 51. At this time, the process block 52 is processing the packet data with coordinates X=1 and Y=3.

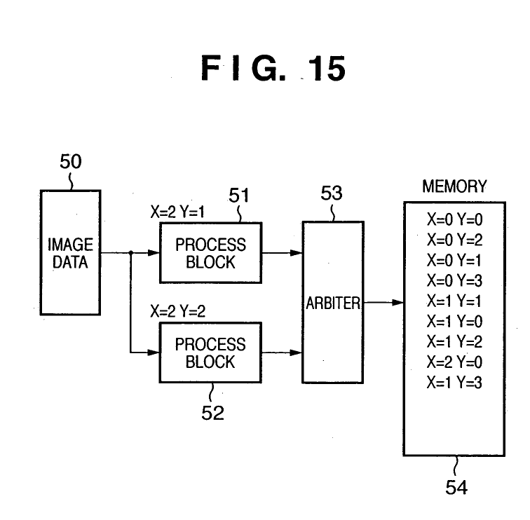

Referring to FIG. 15, the processing of the packet data with coordinates X=1 and Y=3 in the process block 52 is complete, and the processed data is stored at address 08 in the memory 54 through the arbiter 53. Next packet data with coordinates X=2 and Y=2 is newly input to the process block 52. At this time, the process block 51 is processing the packet data with coordinates X=1 and Y=1.

When the processed data are stored in the memory 54 in the above manner, the output order of the tile data differs from the order of the initial packets.

In this system, if the packet format described above is not used, since the image data has no positional information, the processed data cannot be restored to the data in the initial order. In contrast to this, in the case of the packet format, the positional information (X- and Y-coordinate data) of each tile data is added to the corresponding header portion, and the storage addresses of the respective tile data in the memory 54 are managed by the packet table format. Therefore, even packet data input to the memory 54 in random order can be read out and output from the memory 54 in the initial order.

In a large-scale system like that described above, if large-volume data is exchanged between the respective process blocks in image data processing, a long processing time is required. In general, therefore, image data is exchanged in a compressed state. The compressed data is decoded when it is actually output.

The image data sent from a FAX, PC, image database, or the like into the system through a network has already been compressed, and hence can be exchanged between the respective process blocks without compression. However, the image data input from a scanner is compressed first, and then the compressed information is stored in the memory. This information is used for subsequent processing.

The flow of data in such processing will be described below with reference to FIGS. 1A and 1B. This embodiment exemplifies a case wherein after scanned image is compressed to be stored in a memory, and the data is read out from the memory, the data is decompressed and output by a printer.

The scanner image processing unit 2114 corrects the image data input from the scanner 2070, i.e., the image data obtained by scanning. The corrected image data is then input to the tile compression unit 2106 through the image input interface 2112 and tile bus 2107. In this embodiment, the tile compression unit 1 (2106) performs compression by JPEG. The data compressed by the tile compression unit 1 (2106) is stored in the RAM 2002 through the image ring interface 4 (2102), image ring interface 2 (2148), system bus bridge 2007, and RAM controller 2124. The data compressed and stored in the RAM 2002 in this manner is sent to a process block, e.g., a printer unit, FAX unit, or LAN, in accordance with the purpose, through the system bus bridge 2007.

Subsequently, the image data stored in the RAM 2002 is read out by the RAM controller 2124 to be output to the LAN through the system bus bridge 2007 and LAN interface 2010 or stored in the external storage device 2004 such as a hard disk through the general-purpose bus interface 2142.

This embodiment exemplifies a case wherein data in the RAM 2002 is printed by the printer 2095. In this case, data is read out from the RAM 2002 by the RAM controller 2124 and input to the tile decompression unit 1 (2103) through the system bus bridge 2007, image ring interface 1 (2147), and image ring interface 3 (2101). The tile decompression unit 1 (2103) decodes the coded data previously compressed by the tile compression unit 1 (2106) by JPEG. The decoded data in the packet format is then converted from the tile data in the packet form into raster data for printer output operation. After image processing is done by the printer image processing unit 2115, the resultant data is printed by the printer 2095.

In this case, as the RAM 2002, a memory having a sufficient capacity for the storage of image data needs to be used. In practice, however, in view of cost, a very large memory cannot be used. In practice, therefore, based on the premise that data compressed to a certain degree are stored, a memory having a capacity corresponding to such data is prepared.

In the above arrangement, compression is performed by JPEG, in order to handle data with as high image quality as possible in a subsequent process block, the data must be compressed at as low a compression ratio as possible. That is, image data is preferably compressed to a data capacity within the RAM 2002 at as low a compression ratio as possible.

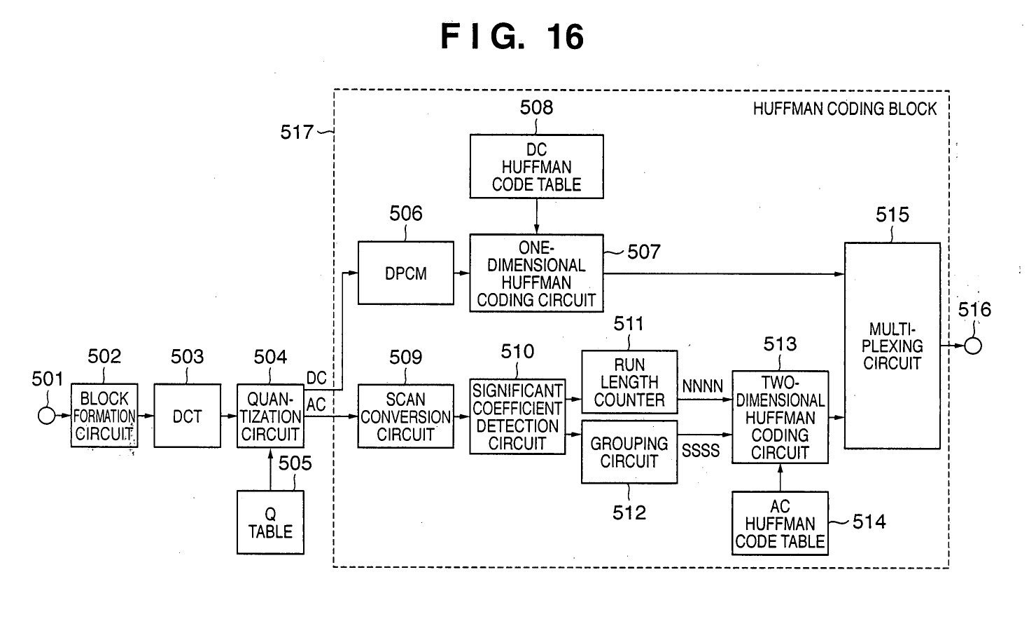

The JPEG compression method will be described first. FIG. 16 is a block diagram showing an arrangement using the JPEG coding scheme.

Referring to FIG. 16, the image pixel data input from an input terminal 501 is divided into 8×8 pixel blocks by a block formation circuit 502 and cosine-transformed by a discrete cosine transform (DCT) circuit 503. The resultant transform coefficients are supplied to a quantization circuit 504. The quantization circuit 504 linearly quantizes the transform coefficients in accordance with the quantization step information supplied from a quantization table (Q table) 505. The quantized values are then output to a Huffman coding block 517.

The Huffman coding block 517 performs the following processing. A predictive coding circuit (DPCM) 506 obtains the difference (predictive error) between the DC coefficient, of the quantized transform coefficients, in the current bock and that in the preceding block, and supplies the difference to a one-dimensional Huffman coding circuit 507.

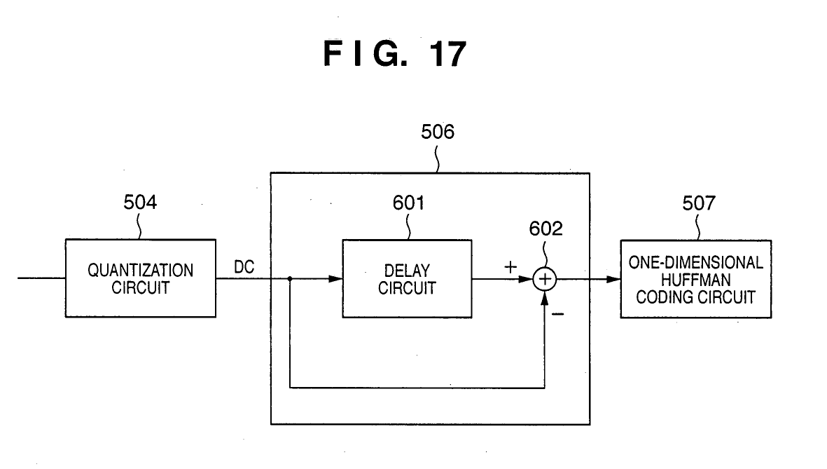

FIG. 17 is a block diagram showing the detailed arrangement of the predictive coding circuit (DPCM) 506. Referring to FIG. 17, the DC coefficients quantized by the quantization circuit 504 are applied to a delay circuit 601 and subtracter 602. The delay circuit 601 is a circuit for providing a delay time necessary for the discrete cosine transform (DCT) circuit 503 perform computation corresponding to one block, i.e., 8×8 pixel data. The delay circuit 601 supplies the DC coefficient of the preceding block to the subtracter 602. The subtracter 602 therefore outputs the difference (predictive error) between the DC coefficient in the current block and that in the preceding block (since this predictive encoding operation uses the preceding block values as a predictive value, a prediction device is formed from a delay circuit as described above). The one-dimensional Huffman coding circuit 507 variable-length codes the predictive error signal supplied from the predictive coding circuit 506 in accordance with a DC Huffman code table 508, and supplies a DC Huffman code to a multiplexing circuit 515.

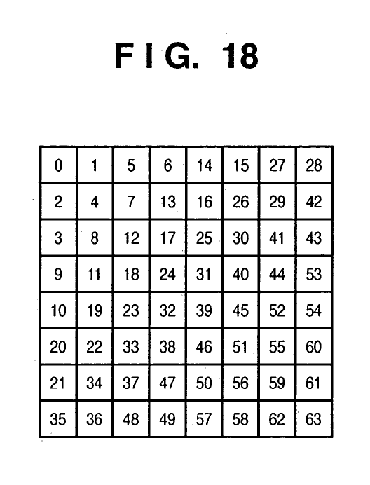

The AC coefficients (coefficients other than the DC coefficients) quantized by the quantization circuit 504 are zigzag-scanned by a scan conversion circuit 509 in the order of increasing degree to be supplied to a significant coefficient detection circuit 510. In this zigzag scanning, the two-dimensional DCT results are scanned in accordance with the order shown in FIG. 18 (from 0 to 63) to be converted into one-dimensional continuous data.

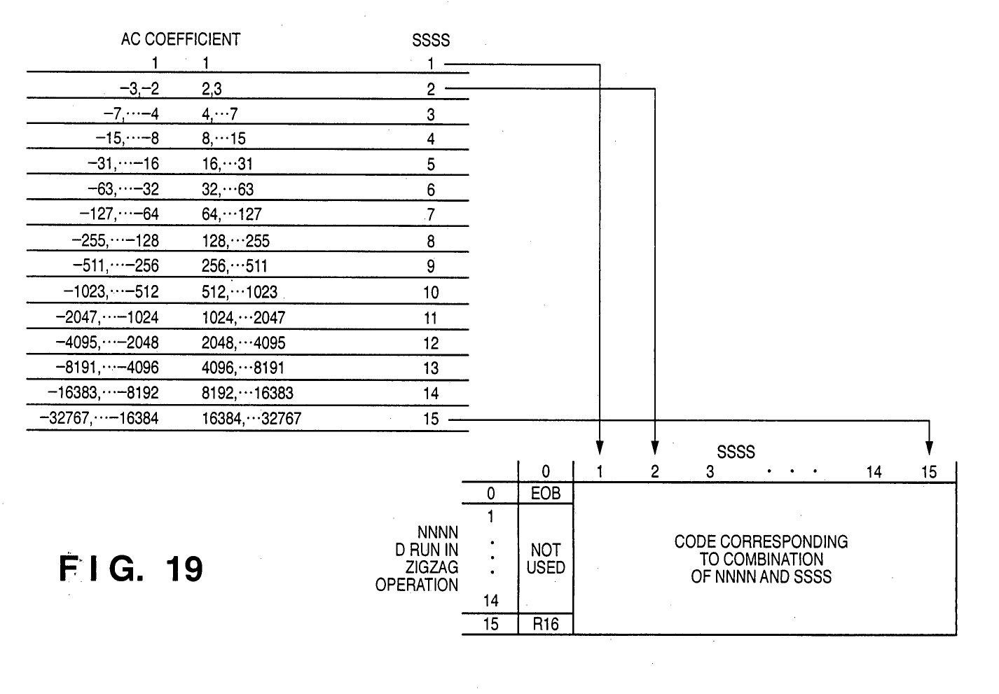

The significant coefficient detection circuit 510 determines whether each quantized AC coefficient is “0”, and supplies a count-up signal to a run length counter 511 when the coefficient is “0”, thereby incrementing the counter value by one. If the AC coefficient is other than “0”, the significant coefficient detection circuit 510 supplies a reset signal to the run length counter 511 to reset the value of the run length counter 511 to “0”. In addition, as shown in FIG. 19, a grouping circuit 512 divides the coefficient into a group number SSSS and an additional bit. The group number SSSS and additional bit are respectively supplied to a two-dimensional Huffman coding circuit 513 and the multiplexing circuit 515.

Referring to FIG. 19, “EOB” is a delimiter code indicating the end of coding of one block (8×8 pixels), and “R16” is a code used when the run of Os is 16 or more. The run length counter 511 is a circuit for counting a run length of “0”s. The run length counter 511 supplies a number NNNN of “0”s between significant coefficients other than “0” to the two-dimensional Huffman coding circuit 513. The two-dimensional Huffman coding circuit 513 variable-length codes the run length NNNN of “0”s and the group number SSSS of significant coefficients in accordance with a AC Huffman code table 514 and supplies the AC Huffman code to the multiplexing circuit 515.

The multiplexing circuit 515 receives a DC Huffman code, AC Huffman code, and additional bit corresponding to one block (8×8 input pixels), multiplexes them, and outputs the resultant data, as compressed image data, from an output terminal 516. The compressed data output from the output terminal 516 is stored in the memory, and is decompressed when it is read out, thus reducing the memory capacity.

Note that data coded by JPEG is decoded in a reverse flow to that in coding.

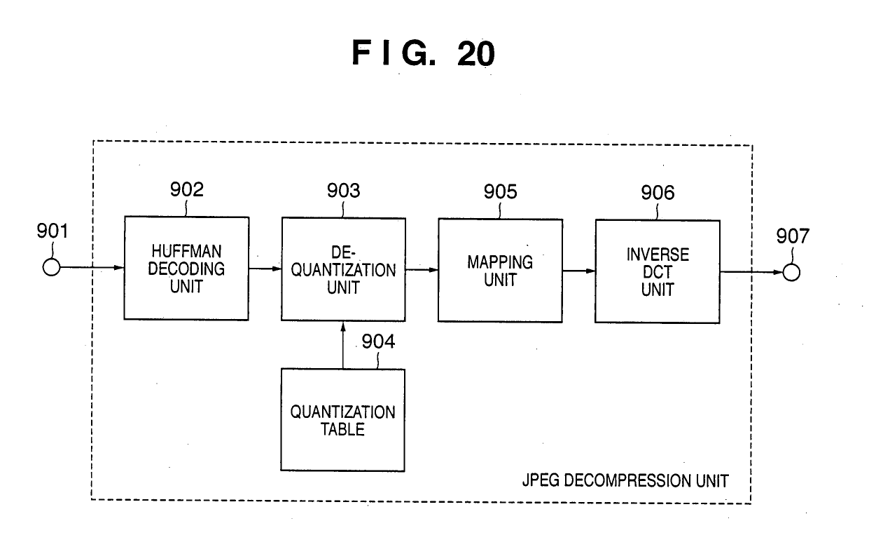

FIG. 20 is a block diagram for explaining the flow of decoding. As shown in FIG. 20, the image pixel data input from an input terminal 901, which is Huffman-coded, is decoded by a Huffman decoding unit 902. A de-quantization unit 903 performs de-quantization by using a quantization table 904 for decoding which is based on the quantization table created for coding. A mapping unit 905 maps the one-dimensional continuous data obtained by zigzag-scanning the DCT coefficients into two-dimensional data again. An inverse DCT unit 906 decodes the data by performing inverse discrete cosine transform for each 8×8 area, and outputs the decoded data from an output terminal 907.

In order to perform the above data compression and store the image data in a memory having a limited capacity, the following processing is generally performed. Assume that in this case, the memory capacity of the RAM 2002 is 1/16 that of original image data.

In JPEG compression by the tile compression unit 1 (2106), compression is performed first by using a quantization table (Q₈) with a predictive compression ratio of 1/8. In this case, it is highly possible that the amount of coded data after the compression processing will exceed the memory capacity of the RAM 2002. However, since JPEG compression is variable length coding, image data may be compressed at a compression ratio higher than the predictive compression ratio depending on the contents of the image data. The above quantization table (Q₈) is therefore used first. If the coded data is actually compressed to 1/16 or less of the original data, the coded data is directly stored in the RAM 2002.

If the data compressed by using the above quantization table (Q₈) exceeds the memory capacity of the RAM 2002, however, compression is performed next by using a quantization table (Q₁₆) with a predictive compression ratio of 1/16. If the data is compressed by this compression below the capacity of the RAM 2002, the coded data is stored in the RAM 2002. Depending on the contents of the image data, however, the data may be compressed at a compression ratio lower than the predictive compression ratio. At this time, the data cannot be fully stored in the RAM 2002 with the prepared memory capacity. In such a case, therefore, compression is performed by using a quantization table (Q₃₂) with a predictive compression ratio of 1/32. The data is compressed by this compression below the memory capacity of the RAM 2002, the data is stored in the RAM 2002.

Compressing image data while sequentially switching quantization tables with higher compression ratios (Q₈→Q₁₆Q₃₂→ . . . ) until the data falls within the memory capacity of the RAM 2002 makes it possible to finally obtain coded data of the amount which can be stored in the RAM 2002. As a consequence, the data can be compressed at a low compression ratio as possible.

In this method, however, since compression is repeated a plurality of number of times, several problems arise. First, a plurality of quantization tables must be prepared. This leads to an increase in a memory in which quantization tables are stored. In addition, in decoding data, the same quantization tables as those used in coding must be used, and hence a plurality of quantization tables are required for a unit which performs decoding, such as the tile decompression unit 2103. This leads to an increase in a memory in which quantization tables are stored.

Second, when compression is to be performed after the predictive compression ratio is changed, the original image must be scanned again by the scanner 2070. This increases the time required between the instant at which first coding is started and the instant at which final coding is complete.

Without concern for an increase in processing time, original images can be scanned one by one, i.e., the same image can be repeatedly scanned. If, however, images are continuously scanned by using an auto sheet feeder or the like, both scanning and coding must be performed in real time. That is, rescanning operation cannot be done. In order to perform such rescanning operation, the user must set an original again. This is cumbersome for the user.

In order to solve the above problems, this embodiment uses the following processing method. Assume that image data is to be input/output as data in the above tile image (packet) format. More specifically, as shown in FIG. 4, image data is divided into tiles each consisting 32×32 pixels, X- and Y-coordinates are determined, and the corresponding coordinate data is set in a header portion. Image data corresponding to one tile, i.e., 1,024 pixels, is set in an image data portion. Note that as shown in FIG. 5, in this image data portion, RGB data is set when it is input from the scanner 2070. When this RGB data is compressed, the compression-coded data is set in the image data portion.

The tile compression unit uses pluralities of coding circuits and decoding circuits to compress image data by JPEG in real time within the memory capacity of the RAM 2002, and outputs the resultant data. Performing bit shifting (bit shifting to the right) instead of having a plurality of quantization tables can achieve a reduction in the memory capacity for the storage of quantization tables.

The following is the effect of bit shifting (bit shifting to the right in the JPEG compression unless otherwise specified) quantized data by a bit shifter.

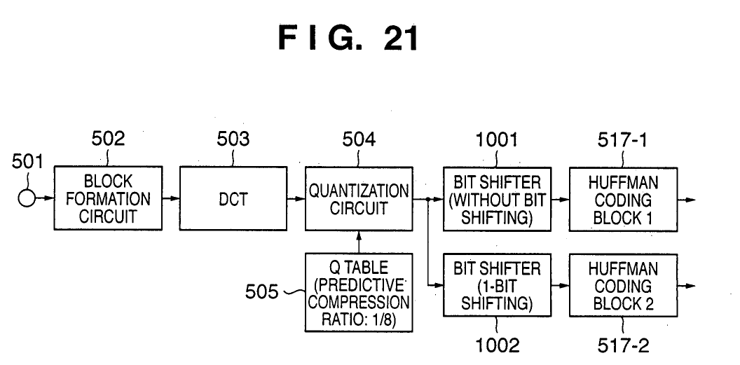

FIG. 21 is a view showing the arrangement of a data compression system having a bit shifter. The same reference numerals as in FIG. 16 denote the same parts in FIG. 21, and a repetitive description will be avoided.

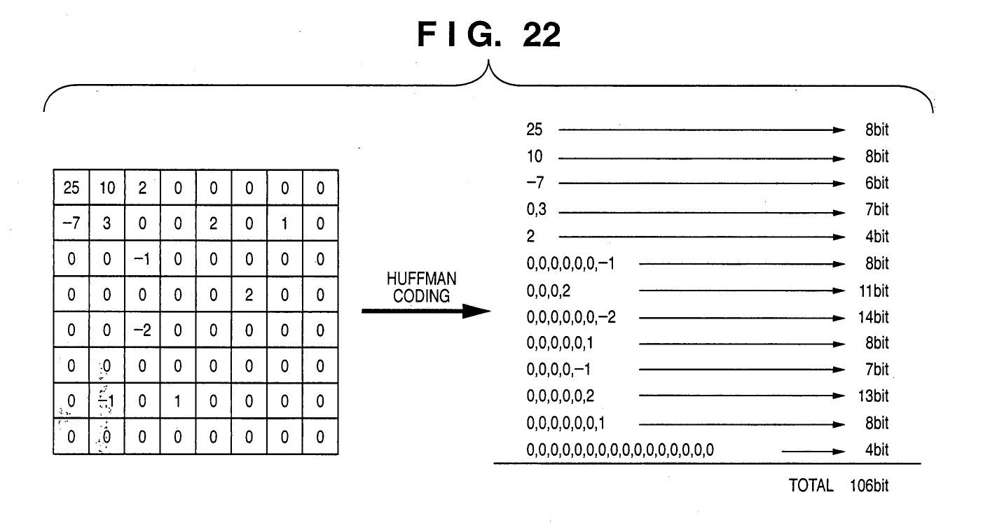

The quantization table 505 used in this description is a quantization table (Q₈) with a predictive compression ratio of 1/8. The CPU 2001 forbids a bit shifter 1001 to perform bit shifting while making a bit shifter 1002 perform 1-bit shifting (1/2 computation). With such settings, when a quantization result like that shown on the left side in FIG. 22 is obtained as a result of quantizing given image data, this bit shifter 1001 compresses the quantization result by Huffman coding to obtain 106-bit compressed data like that shown on the right side in FIG. 22 because the bit shifter 1001 is forbidden to perform bit shifting.

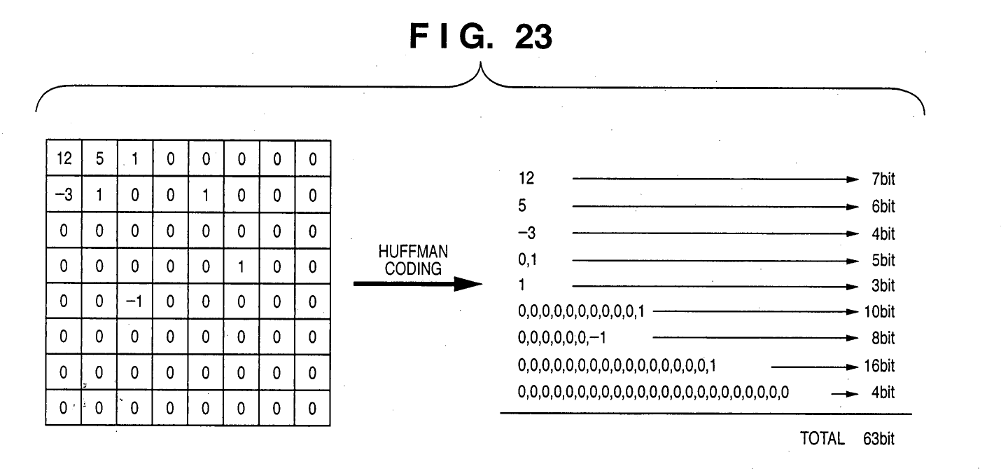

The bit shifter 1002 is made to perform 1-bit shifting, and hence the quantization result output from the bit shifter 1002 becomes values like those shown on the left side in FIG. 23. As shown in FIG. 23, portions of quantized data which have been “1” and “−1” become “0” after bit shifting. For this reason, when quantized data is zigzag-scanned, and its sequence is coded, continuations of “0”s occur in many portions. As a result, when this data is compressed by Huffman coding, 63-bit compressed data like that shown on the right side in FIG. 23 is obtained.

According to this method, when a standard image is processed, the data amount can be compressed to about ½, although the amount of compressed data is not accurately reduced to ½.

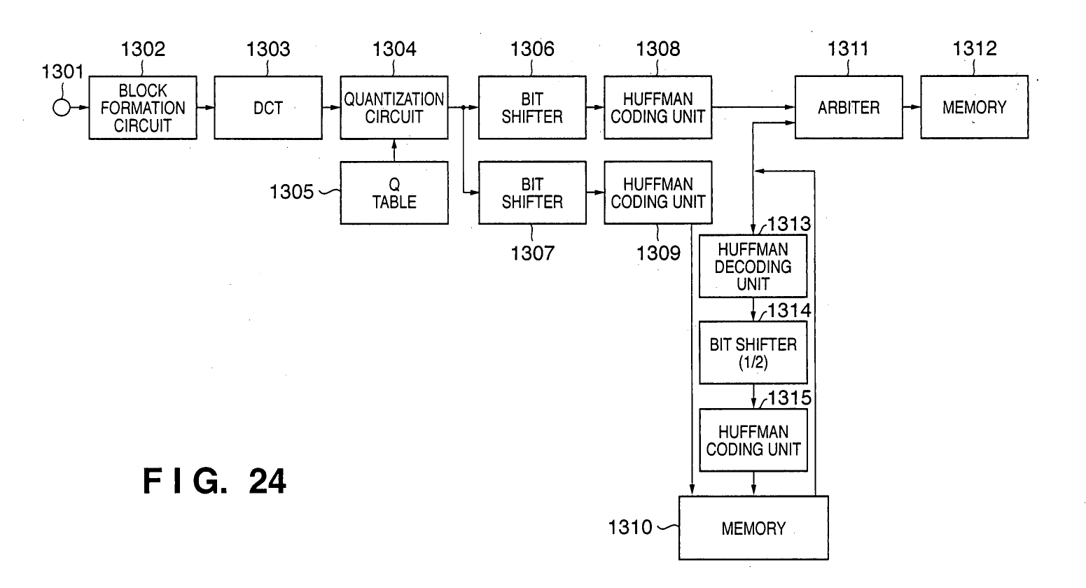

FIG. 24 is a block diagram showing the arrangement of a JPEG compression unit which is used inside the tile compression unit 1 (2106) and realizes JPEG compression so as solve the above problems.

Referring to FIG. 24, a memory 1312 corresponds to the RAM 2002 in FIG. 1A, and the image ring interface 4 (2102), image ring interface 2 (2148), system bus bridge 2007, and RAM controller 2124 are not illustrated.

Referring to FIG. 24, an input terminal 1301 is an interface portion which receives image data from the tile bus 2107. The pixel data input from the sample input terminal 1301 is divided into 8×8 pixel blocks by a block formation circuit 1302 and cosine-transformed by a discrete cosine transform (DCT) circuit 1303. The resultant transform coefficients are supplied to a quantization circuit 1304. The quantization circuit 1304 linearly quantizes the transform coefficients in accordance with the quantization step information supplied from a quantization table 1305. The quantized data output from the quantization circuit 1304 is input to bit shifters 1306 and 1307. In this case, each bit shifter has a function of reducing 8×8 quantized data to ½, ¼, or ⅛ by bit shifting. Note that information indicating a specific number of bits by which data should be shifted is controlled by the CPU 2001 (FIG. 1A). In addition, the bit shift count of the bit shifter 1306 is smaller than that of the bit shifter 1307 by one. The quantized data output from the bit shifters 1306 and 1037 are respectively input to Huffman coding units 1308 and 1309 to be compressed by the coding method described in detail above.

The data coded by the Huffman coding unit 1308 is input to an arbiter 1311 and stored in the memory 1312. The coded data output from the Huffman coding unit 1309 is input to a memory 1310. Assume that data input/output operation of the memory 1310 is controlled by the CPU 2001. The data output from the memory 1310 is stored in the memory 1312 through the arbiter 1311 and decoded into the original quantization table by a Huffman decoding unit 1313. The data decoded in this manner is shifted by one bit (1/2) by a bit shifter 1314. The quantization result shifted by one bit by the bit shifter 1314 is coded again by a Huffman coding unit 1315 and input to the memory 1310.

A method of compressing data at as low a compression ratio as possible at which the data can be stored in the memory 1312 in real time by using the tile compression unit 2106 having the above arrangement will be described below.

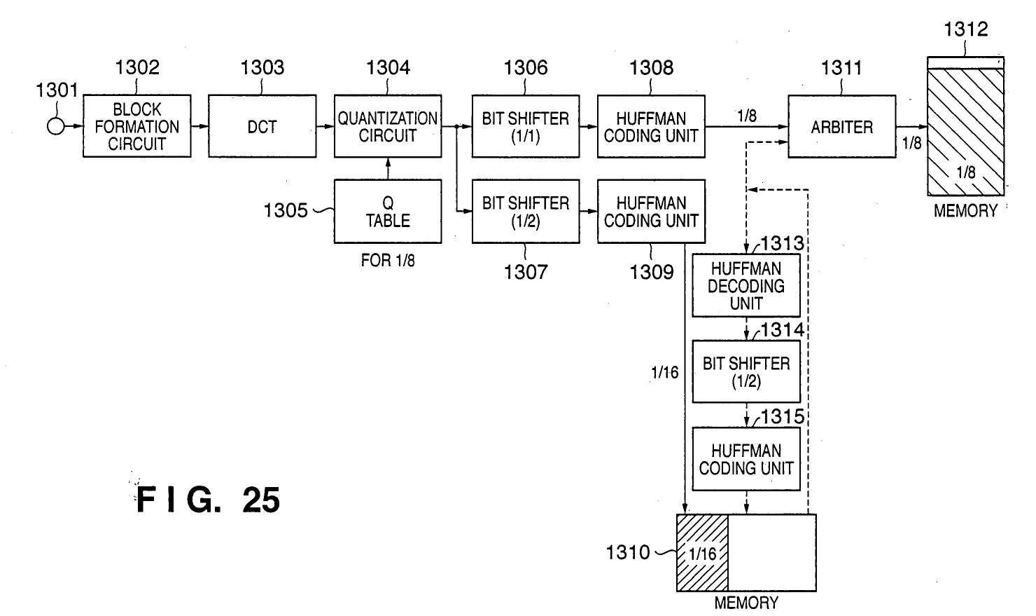

FIGS. 25 to 32 are views for explaining a method which is based on the arrangement shown in FIG. 24 and compresses data at as low a compression ratio as possible at which the data can be stored in the memory 1312 in real time. Assume that this embodiment is based on the premise that as the quantization table 1305, a table with a predictive compression ratio of 1/8 is used. Assume also that the memory 1312 has a memory capacity which allows it to store original image data up to 1/16 of its capacity. Note that in FIGS. 25 to 32, the solid arrows indicate the paths through which data flow, and the dotted arrow indicate the paths through which no data flow in the states shown in the drawings. The same reference numerals as in FIG. 24 denote the same parts in FIGS. 25 to 32, and a description thereof will be omitted.

In starting processing, as shown in FIG. 25, the bit shifter 1306 makes settings for O-bit shifting (through). The bit shifter 1307 makes settings for 1-bit shifting (1/2). When input image data is compressed upon the above settings, image data compressed at a predictive compression ratio of 1/8 is output from the Huffman coding unit 1308 and stored in the memory 1312. Image data compressed at a predictive compression ratio of 1/16 is output from the Huffman coding unit 1309 and stored in the memory 1310. In this case, no data is output from the memory 1310.

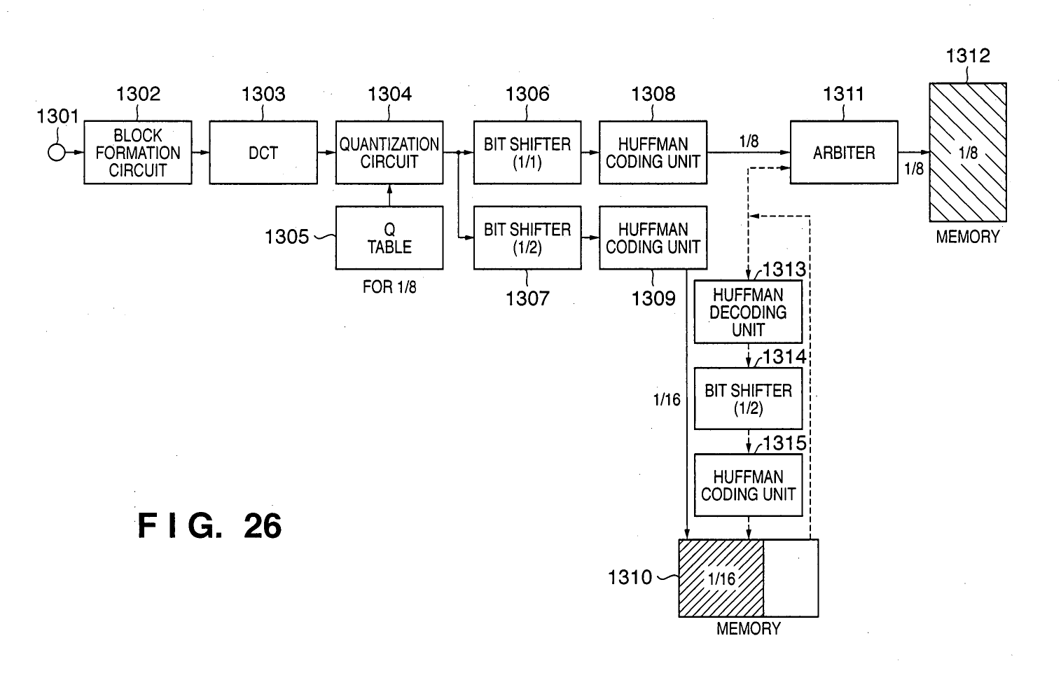

Assume that processing is performed on the basis of these settings and the data capacity of the memory 1312 is filled to data capacity as shown in FIG. 26 because the actual compression ratio is not sufficiently high. In this case, the memory 1312 is reset to clear all the coded data stored therein so far.

This resetting operation serves to transfer the roles of the bit shifter 1307, Huffman coding unit 1309, and memory 1310 to the bit shifter 1306, Huffman coding unit 1308, and memory 1312. In addition, new roles are assigned to the bit shifter 1307, Huffman coding unit 1309, and memory 1310.

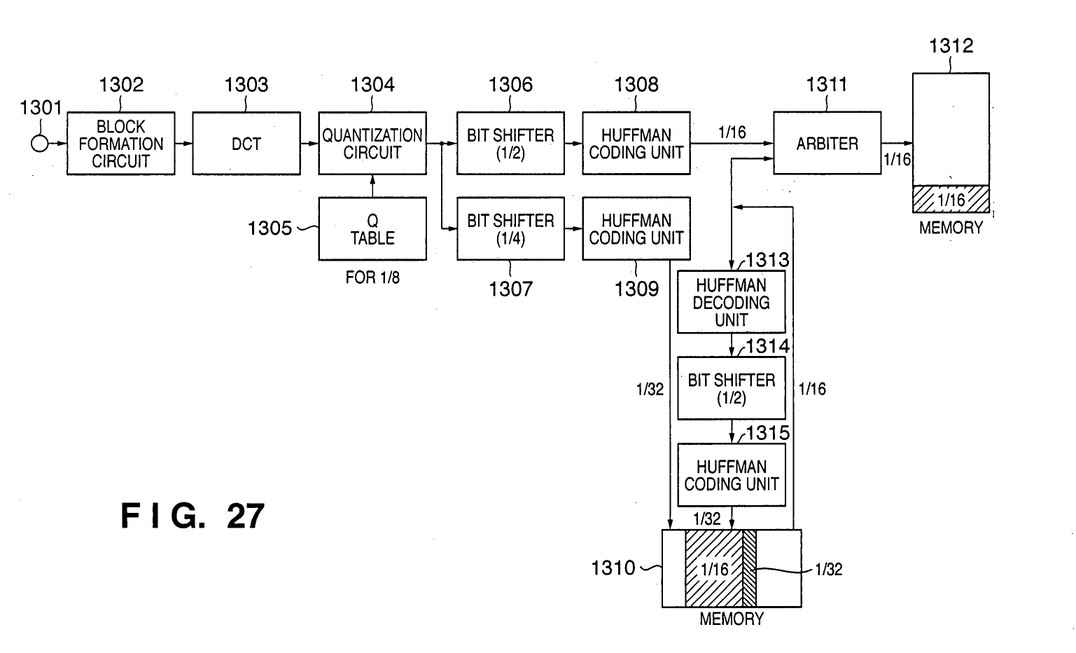

When the data in the memory 1312 are cleared, the bit shifter 1306 is set to 1-bit shifting (1/2) again, as shown in FIG. 27. In addition, the bit shifter 1307 is set to 2-bit shifting (1/4) again. That is, even in the process of coding a 1-page image, the respective bit shifters make resetting for increasing the compression ratio of image data to be subsequently input by one step. In addition, the coded image data that have already been compressed at a predictive compression ratio of 1/16 and stored in the memory 1310 are transferred, from the start portion of the data up to the portion corresponding to a timing immediately before the above resetting operation, to the memory 1312 through the arbiter 1311 and stored in the memory 1312.

The area in the memory 1310 in which data output from the memory 1310 has been stored is reset and is used as a storage portion when the next data is input.

The Huffman coding unit 1308 Huffman-codes the data input from the input terminal 1301, quantized, and shifted by one bit by the bit shifter 1306 after the resetting operation, and outputs the resultant data as image data compressed at a predictive compression ratio of 1/16. This image data is then stored in the memory 1312. The memory 1312 receives both the data compressed at a predictive compression ratio of 1/16 and input from the memory 1310, transferred from the start portion, and the interim data compressed at a predictive compression ratio of 1/16 and input from the Huffman coding unit 1308. As described above, however, since the positional information of each data is managed in the form of a packet format by a packet table, the data can be output from the memory 1312 afterward in the order in which the data were input from the scanner 2070. In addition, at this time, the Huffman coding unit 1309 outputs image data compressed at a predictive compression ratio of 1/32, and the output data is stored in an available area in the memory 1310. The data output from the memory 1310 is input to the memory 1312, and at the same time, decoded by the Huffman decoding unit 1313 to be restored to the quantized data. The quantized data is shifted by one bit (1/2) by the bit shifter 1314. The data is then coded again by the Huffman coding unit 1315 and stored, as coded data compressed at a predictive compression ratio of 1/32, in the memory 1310.

That is, the memory 1310 receives both the data compressed at a predictive compression ratio of 1/32 and input from the Huffman coding unit 1315, transferred from the start portion, and the interim data compressed at a predictive compression ratio of 1/32 and input from the Huffman coding unit 1309. As described above, however, since the positional information of each data is managed in the form of a packet format by the packet table, the data can be output afterward from the memory 1312 in the order in which the data were input from the scanner 2070.

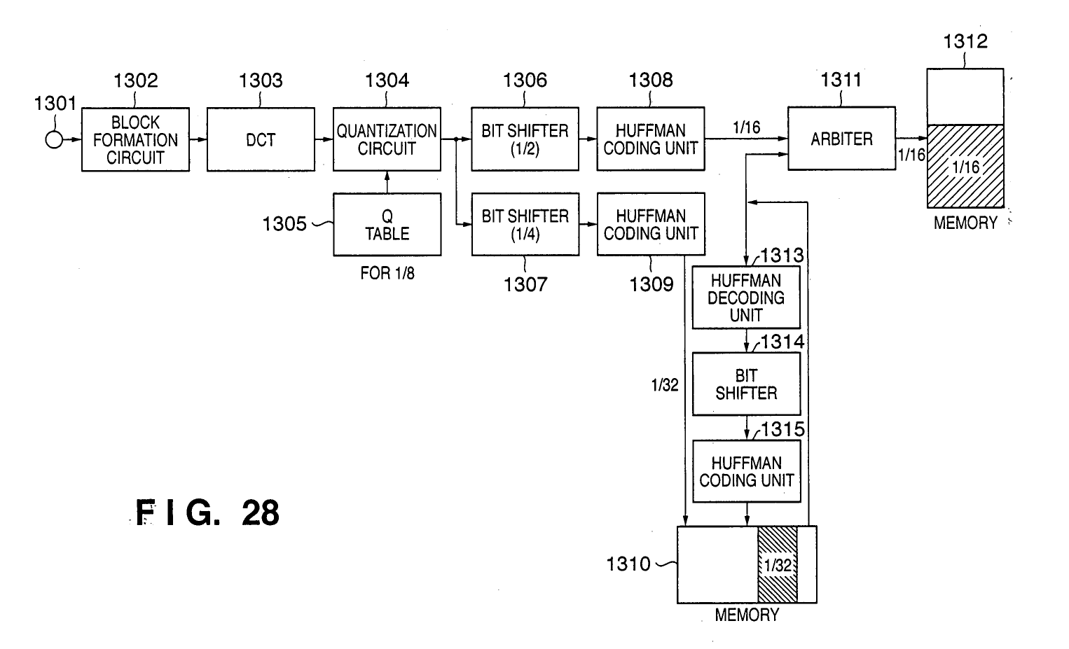

When all the data compressed at a predictive compression ratio of 1/16 and stored in the memory 1310 are output to the memory 1312 as shown in FIG. 28, outputting of data from the memory 1310 is stopped, and only data from the Huffman coding unit 1308 is input to the memory 1312 to be stored. Meanwhile, data from the Huffman coding unit 1309 is stored in the memory 1312. When all the data compressed at a predictive compression ratio of 1/16 are stored in the memory 1312 by continuing this processing, the compression is complete.

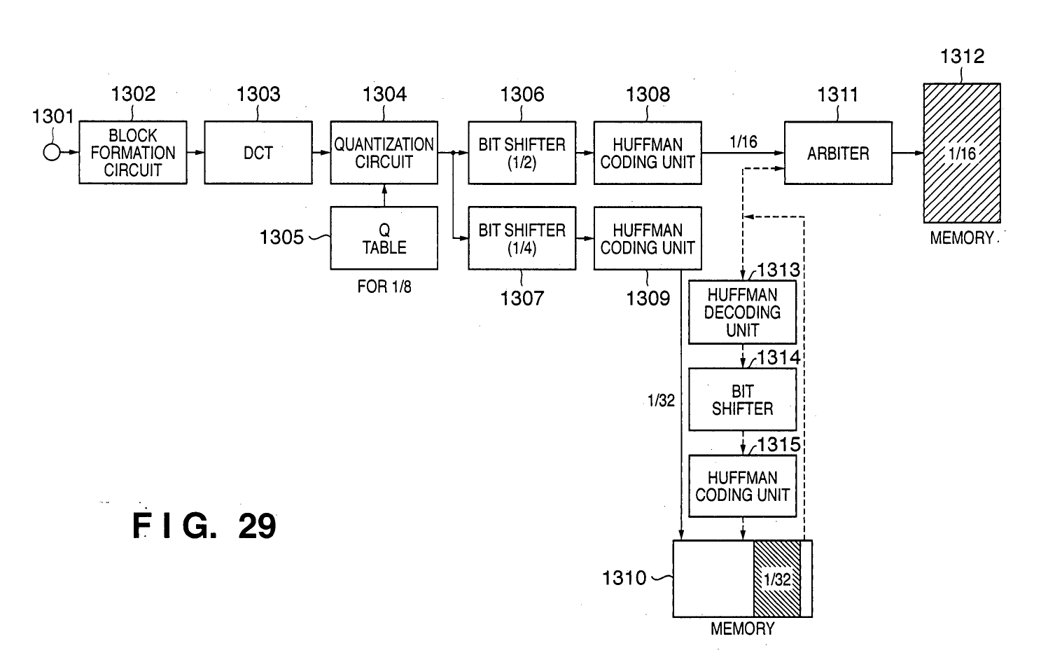

Depending on the contents of images to be compressed, however, the image data may be compressed at a predictive compression ratio lower than 1/16 and hence cannot be completely stored in the memory 1312, as shown in FIG. 29. When the actual compression ratio is not satisfactorily high, and the memory 1312 is filled with coded data as in this case, the memory 1312 is reset to clear the data stored in the memory 1312.

Like the previous resetting operation, this resetting operation serves to transfer the roles of the bit shifter 1307, Huffman coding unit 1309, and memory 1310 to the bit shifter 1306, Huffman coding unit 1308, and memory 1312, and assigns new roles to the bit shifter 1307, Huffman coding unit 1309, and memory 1310.

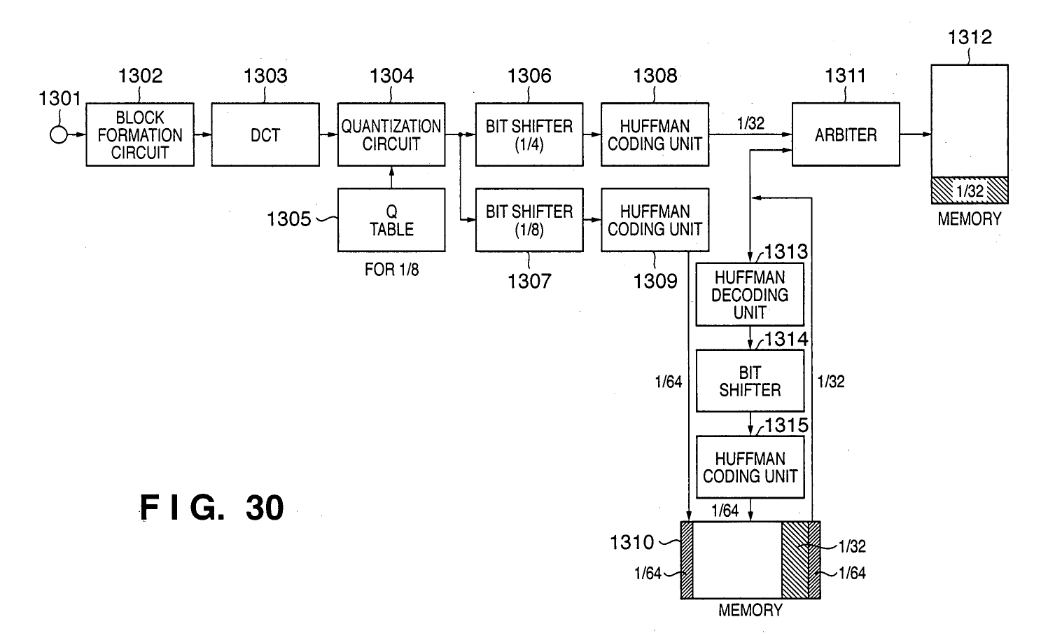

After the coded data in the memory 1312 are cleared, the bit shifter 1306 is set to 2-bit shifting (1/4) again, as shown in FIG. 30. In addition, the bit shifter 1307 is set to 3-bit shifting (1/8). The coded image data compressed at a predictive compression ratio of 1/32 and stored in the memory 1310 are output, from the start portion of the image data up to the data corresponding to a timing immediately before the current resetting operation, and are stored in the memory 1312 through the arbiter 1311. The portion in which the data output from the memory 1310 have been stored is reset to be used as a storage portion when the next data is input.

The Huffman coding unit 1308 Huffman-codes the data input from the input terminal 1301, quantized, and shifted by two bits by the bit shifter 1306 after the resetting operation, and outputs the resultant data as image data compressed at a predictive compression ratio of 1/32. This image data is then stored in the memory 1312. The memory 1312 receives both the data compressed at a predictive compression ratio of 1/32 and input from the memory 1310, transferred from the start portion, and the interim data compressed at a predictive compression ratio of 1/32 and input from the Huffman coding unit 1308. As described above, however, since the positional information of each data is managed in the form of a packet format by a packet table, the data can be output from the memory 1312 afterward in the order in which the data were input from the scanner 2070. In addition, at this time, the Huffman coding unit 1309 outputs image data compressed at a predictive compression ratio of 1/64, and the output data is stored in the memory 1310. The data output from the memory 1310 is input to the memory 1312, and at the same time, input to the Huffman decoding unit 1313 to be decoded and restored to the quantized data. The quantized data is shifted by one bit (1/2) by the bit shifter 1314. The data is then coded again by the Huffman coding unit 1315 and stored, as coded data compressed at a predictive compression ratio of about 1/62, in the memory 1310. In this manner, the memory 1310 receives both the data compressed at a predictive compression ratio of 1/64 and input from the Huffman coding unit 1315, transferred from the start portion, and the interim data compressed at a predictive compression ratio of 1/64 and input from the Huffman coding unit 1309.

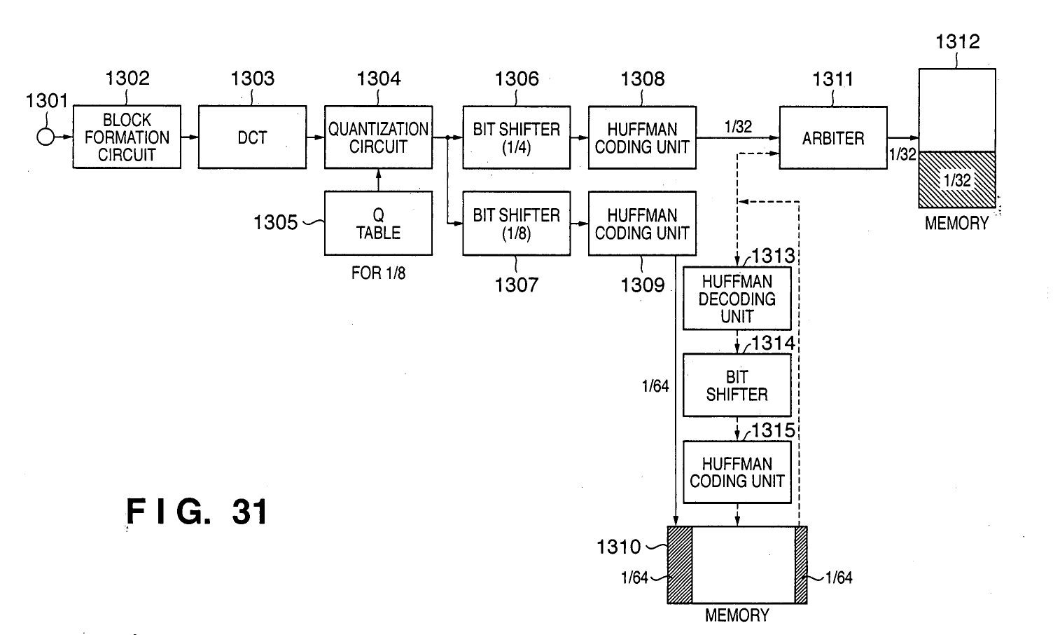

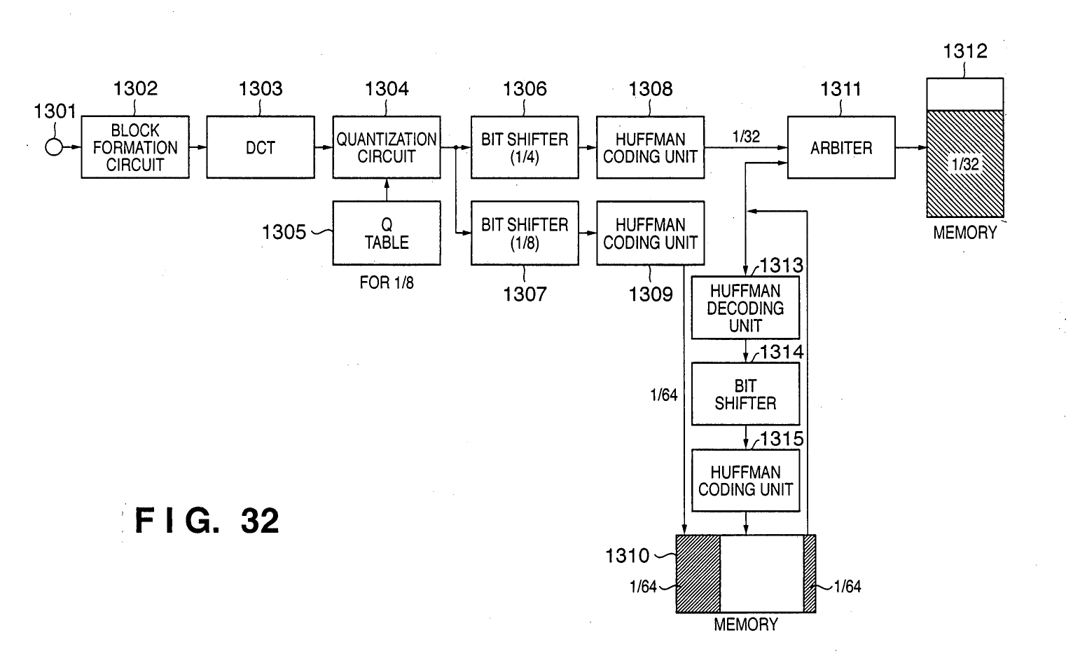

When all the data compressed at a predictive compression ratio of 1/32 and stored in the memory 1310 are output to the memory 1312 as shown in FIG. 31, outputting of data from the memory 1310 is stopped, and only data from the Huffman coding unit 1308 is input to the memory 1312 to be stored. Meanwhile, data from the Huffman coding unit 1309 is stored in the memory 1312. When all the data compressed at a predictive compression ratio of 1/32 are stored in the memory 1312 by continuing this processing (FIG. 32), the compression is complete.

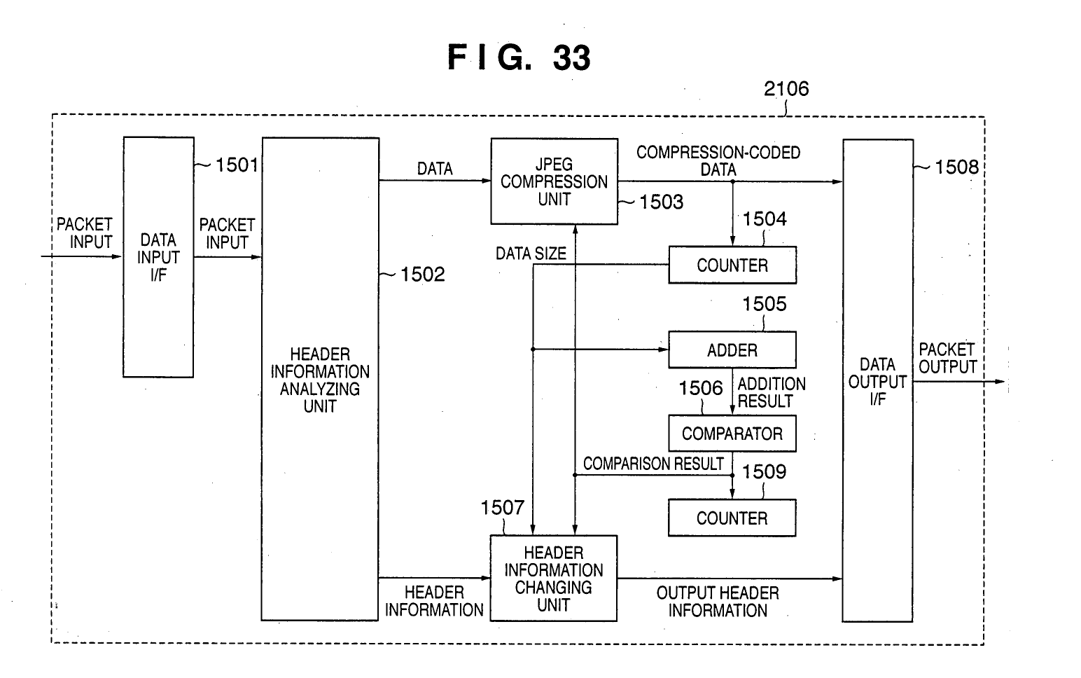

The internal arrangement of the tile compression unit 2106 will be described with reference to FIG. 33. Reference numeral 1501 denotes a data input interface which receives packeted data from the tile bus 2107; and 1502, a header information analyzing unit which reads the information of the header portion of packet data, and outputs it as header information to a header information changing unit 1507. The information of the header portion is input to a JPEG compression unit 1503 to be compressed by the method described in detail above. The data compressed in this manner is output to a data output interface 1508 and is also input to a counter 1504. The counter 1504 counts the data amount of data after compression, and outputs the resultant information as a data size to the header information changing unit 1507 and an adder 1505. The adder 1505 adds the compressed data and outputs the addition result to a comparator 1506. Assume that at this time, addition is performed in consideration of the data amount of the header portion. When the addition result from the adder 1505 exceeds the capacity of the RAM 2002, the comparator 1506 outputs a signal informing this to the JPEG compression unit 1503, the header information changing unit 1507, and a counter 1509. At the same time, the value of the adder 1505 is cleared.

Upon receiving the signal indicating that the capacity is exceeded, the JPEG compression unit 1503 switches to control operation for creating and outputting data at a compression ratio higher than the current compression ratio. The counter 1509 counts how many times the signal indicating that the capacity was exceeded was output, and holds the count value in a register or the like.

The header information changing unit 1507 changes the data size information in the header portion of packet data to the size after compression, and rewrites the compression flag to set it as a data indication after compression. When the comparison result received from the comparator 1506 exceeds the capacity of the RAM 2002, the corresponding information is set as output header information in RAM Rst flag 3022 in the header portion. The header information changed in this manner is input to the data output interface 1508 to be added as the header of the data after compression. The resultant data is then output as packet data to the image ring interface 4 (2102).

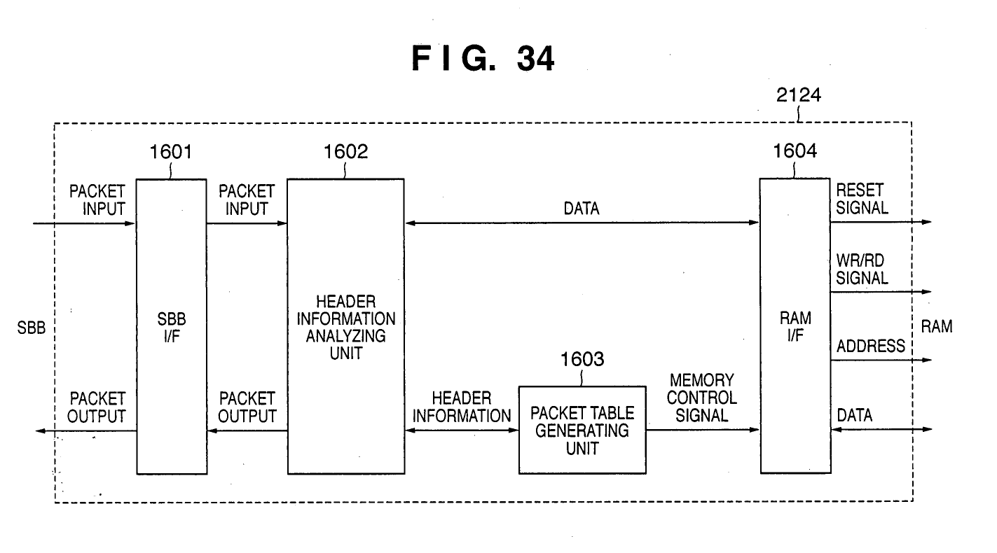

FIG. 34 is a block diagram showing the arrangement of the RAM controller 2124 according to this embodiment. Reference numeral 1601 denotes an SSB interface unit which receives packet data from the system bus bridge and outputs packet data to the system bus bridge; 1602, a header information analyzing unit which reads the header portion of input packet data and analyzes necessary information. When the information of the header portion of packet data to be output is to be corrected, the header information analyzing unit 1602 rewrites the information. Reference numeral 1603 denotes a packet table generating unit which receives XY coordinate information and a data size as header information from the header information analyzing unit 1602 and creates a packet data table on the basis of the header information. A memory reset flag is also input as header information. If “1” is set in this flag, the contents of the RAM 2002 are reset, and the packet data table is also reset. Reference numeral 1604 denotes a RAM interface which creates an address and RAM control signal in accordance with the packet table created by the packet table generating unit 1603 to control the RAM 2002.

The method described above makes it possible to detect that the compressed data stored in the RAM 2002 exceeds the memory capacity of the RAM 2002 and control the system.

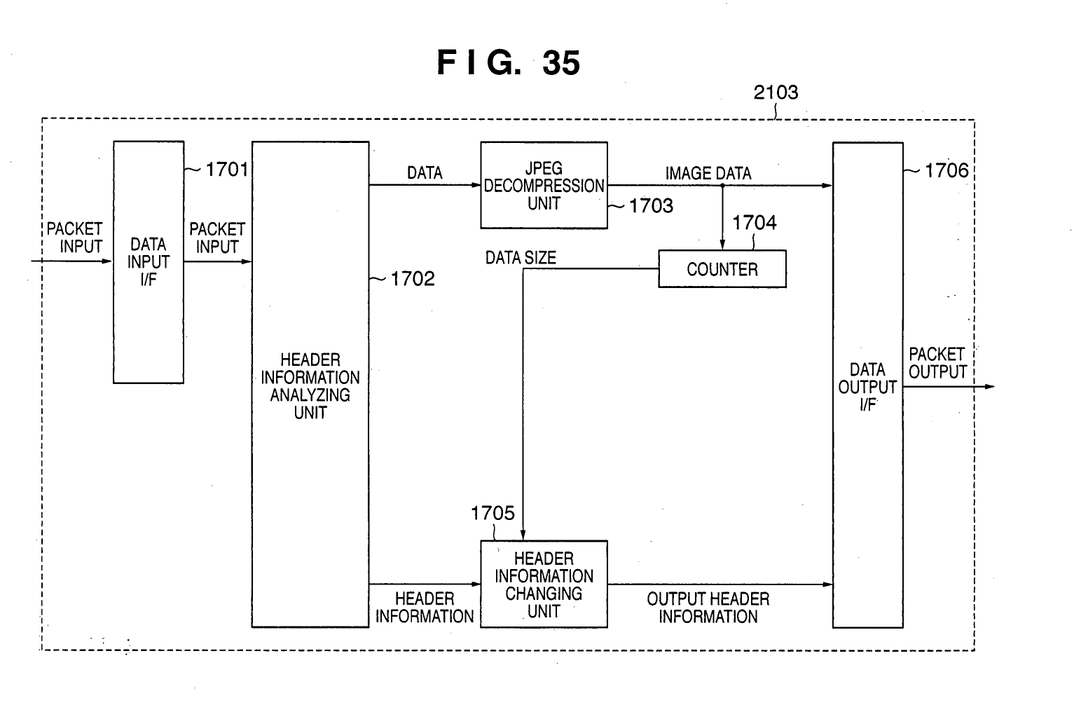

The internal arrangement of the tile decompression unit 2103 which decodes JPEG-compressed data when the coded data is printed will be described next with reference to FIG. 35. Reference numeral 1701 denotes a data input interface which receives packeted data from the image ring interface 3 (2101); and 1702, a header information analyzing unit which reads the information of the header portion of packet data and outputs the information as header information to a header information changing unit 1705. The information of the data portion is input to a JPEG decompression unit 1703 to be JPEG-decoded in the above manner. The data decoded in this manner is output to a data output interface 1706 and the counter 1704. The counter 1704 counts the data amount of data after compression, and outputs the count information as a data size to the header information changing unit 1705. The header information changing unit 1705 changes the data size information in the header portion of the packet data to the size after decompression, and rewrites the compression flag to obtain decompressed image data. The header information changed in this manner is input to the data output interface 1706 and added as the header of the data after decompression. The resultant data is then output as packet data to the tile bus 2107.

When JPEG-compressed data is to be decompressed, a quantization table for decoding must be prepared on the basis of the quantization table used for compression. In general, one quantization table is determined as a table for compression, and hence compression and decoding can be performed by preparing one corresponding quantization table for decoding. In this embodiment, however, a quantization table with a compression ratio of 1/2ⁿ, e.g., 1/8, is used, and the value of n changes in accordance with the capacity of the RAM 2002 in JPEG compression. Therefore, a plurality of quantization tables must be selectively used in accordance with this change.

In this embodiment, the counter 1509 (FIG. 33) in the tile compression unit 2106 has counted the number of times Ram Ret flag was set to “1” in the tile compression unit 2106, and the specific value of n is recognized in advance. Recognized n is then stored in a register in the tile compression unit 2106. When the JPEG-compressed data output from the RAM 2002 is decompressed by the tile decompression unit 2103, the information n is read out to prepare a quantization table for decoding. More specifically, when Ram Ret flag was not set to “1” at all, a quantization table corresponding to 1/8 is prepared. When Ram Ret flag is set to “1” once, a quantization table corresponding to 1/16 is prepared. When Ram Ret flag is set to “1” twice, a quantization table corresponding to 1/32 is prepared. Thereafter, JPEG decoding is performed.

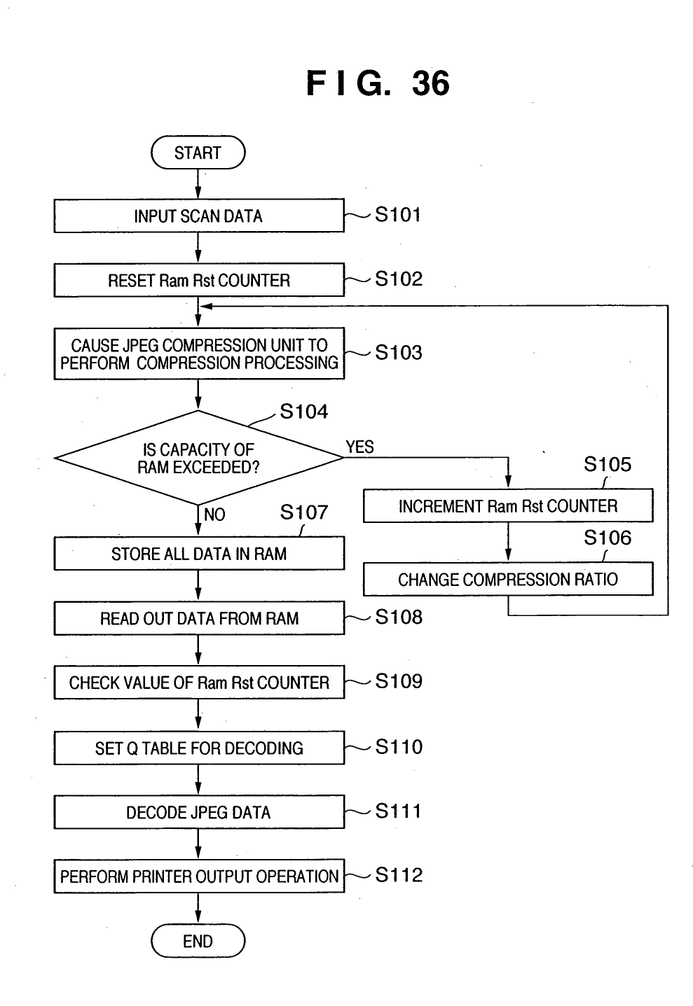

Image processing operation according to this embodiment will be described with reference to the flow chart of FIG. 36. First of all, in step S101, the scanner 2070 scans an original and inputs scan data. The flow then advances to step S102 to reset the value of the counter 1509 (FIG. 33) to “0”, which counts the number of times “1” is set in Ram Rst flag in the tile compression unit 2106. The flow advances to step S103 to compress the image data by using the JPEG compression unit 6003 of the tile compression unit 2106. In step S104, it is checked whether the data obtained by compressing the input image data by the tile compression unit 2106 exceeds the memory capacity of the RAM 2002. If it is determined that the memory capacity of the RAM 2002 is exceeded, the flow advances to step S105 to increment the counter 1509. In step S106, the compression ratio is changed. Thereafter, JPEG data compressed at a higher compression ratio is created.

The compression ratio is increased in this manner and the above processing is repeated until all data can be stored in the RAM 2002, i.e., NO is determined in step S104. If all the image data can be stored in the RAM 2002, the flow advances to step S107 to store the compressed data in the RAM 2002. The flow then advances to step S108 to read out JPEG-compressed data from the RAM 2002 to print the input image data. In step S109, the value of the counter 1509 is acquired. In step S110, a quantization table for JPEG decompression in the tile decompression unit 2103 is set on the basis of the acquired value. The flow then advances to step S111 to decode the JPEG-compressed data by using the tile decompression unit 1 (2103). The flow advances to step S112 to perform predetermined image processing by using the printer image processing unit 2115 and output the processed image data to the printer 2095 so as to print it.

The above processing makes it possible to detect that the memory capacity is exceeded when the data compressed by JPEG exceeds the memory capacity, and to switch processes in the system such that the image data is compressed at a higher compression ratio to make the compressed data fall within the memory capacity.

Holding, in a register or the like, the number of times compressed data has exceeded the capacity allows quick selection of a quantization table in decoding which corresponds to a quantization table used for compression.

[Second Embodiment]

In the first embodiment, the counter 1509 of the tile compression unit 1 (2106) counts the number of times Ram Rst flag is set to “1”, and a quantization table (Q table) for decoding is set on the basis of the count value.

In contrast to this, in the second embodiment, a RAM controller 2124 has a counter, which counts the number of times Ram Rst flag is set to “1”, and decoding is then performed. In addition, decoding is performed, without preparing a plurality of quantization tables, on the basis of the number of times a RAM 2002 is reset in coding operation.

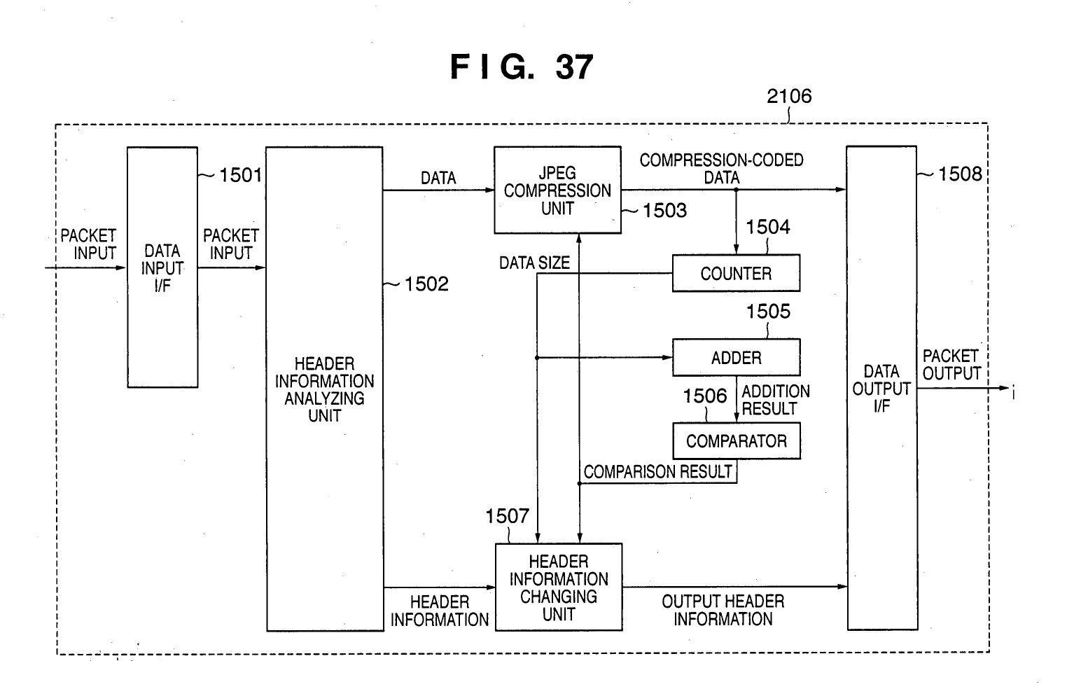

FIG. 37 is a block diagram showing the arrangement of a tile compression unit 1 (2106) according to the second embodiment of the present invention. The same reference numerals as in the first embodiment described with reference to FIG. 33 denote the same parts in the tile compression unit 1 (2106) in this embodiment. A characteristic feature of this arrangement is that it does not include the counter 1509 which counts the number of times Ram Rst flag is set to “1”.

Referring to FIG. 37, reference numeral 1501 denotes a data input interface which receives packeted data from a tile bus 2107; and 1502, a header information analyzing unit which reads the information of the header portion of packet data and outputs the read information as header information to a header information changing unit 1507. The information of the data portion is input to a JPEG compression unit 1503 to be compressed by the above method. The data compressed in this manner is output to a data output interface 1508, and is also input to a counter 1504. The counter 1504 counts the data amount of data after compression, and outputs the resultant information as a data size to the header information changing unit 1507 and an adder 1505. The adder 1505 adds the compressed data and outputs the addition result to a comparator 1506. At this time, addition is performed in consideration of the data amount of the header portion. When the addition result from the adder 1505 exceeds the memory capacity of the RAM 2002, the comparator 1506 outputs a signal informing this to the JPEG compression unit 1503 and the header information changing unit 1507. At the same time, the value of the adder 1505 is cleared. Upon receiving the signal indicating that the capacity is exceeded, the JPEG compression unit 1503 switches to control operation for creating and outputting data at a higher compression ratio. The header information changing unit 1507 changes the data size information in the header portion of packet data to the size after compression, and rewrites the compression flag to set it as a data indication after compression. When the comparison result received from the comparator 1506 exceeds the capacity of the RAM 2002, the corresponding information is set as output header information in RAM Rst flag 3022 in the header portion. The header information changed in this manner is input to the data output interface 1508 to be added as the header of the data after compression. The resultant data is then output as packet data to the image ring interface 4 (2102).

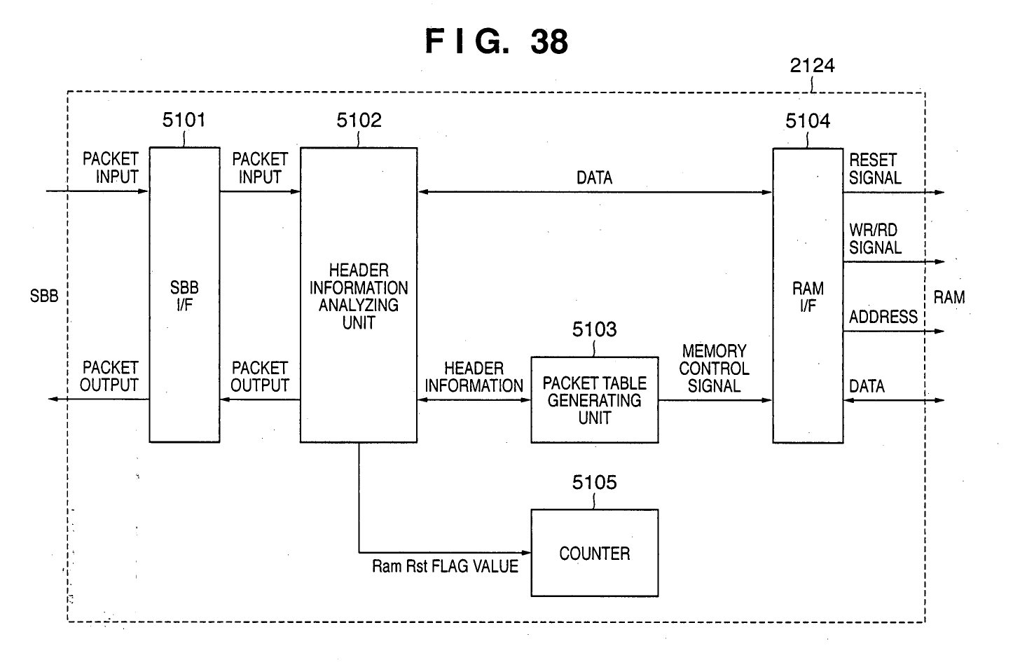

FIG. 38 is a block diagram showing the arrangement of the RAM controller 2124 according to the second embodiment. Reference numeral 5101 denotes an SSB interface unit which receives packet data from the system bus bridge and outputs packet data to the system bus bridge; 5102, a header information analyzing unit which reads the header portion of input packet data and analyzes necessary information. When the information of the header portion of packet data to be output is to be corrected, the header information analyzing unit 1502 rewrites the information. The value of Ram Rst flag 3022 is output from the header information analyzing unit 5102 to a counter 5105. The counter 5105 counts the number of times “1” is set in Ram Rst flag, and holds the count in a register or the like. Reference numeral 5103 denotes a packet table generating unit which receives XY coordinate information and a data size as header information from the header information analyzing unit 5102 and creates a packet data table on the basis of the header information. A memory reset flag is also input as header information. If “1” is set in this flag, the RAM 2002 is reset, and the packet data table is also reset. Reference numeral 804 denotes a RAM interface which creates an address and RAM control signal in accordance with the packet table created by the packet table generating unit 803 to control the RAM 2002. Assume that the JPEG-compressed data output from the RAM 2002 is to be processed by a tile decompression unit 1 (2103). In this case, reading out information from the counter 5105 makes it possible to detect how many times bit shifting was performed in JPEG coding. That is, when Ram Rst flag 3022 was not set to “1” at all, bit shifting was not performed by using the quantization table corresponding to 1/8. When Ram Rst flag 3022 was set to “1” only once, bit shifting was performed once by using a quantization table corresponding to 1/8. When Ram Rst flag was set to “1” twice, bit shifting was performed twice by using the quantization table corresponding to 1/8. The JPEG compression unit 1503 of the tile decompression unit 1 (2103) decodes the JPEG data on the basis of this information.

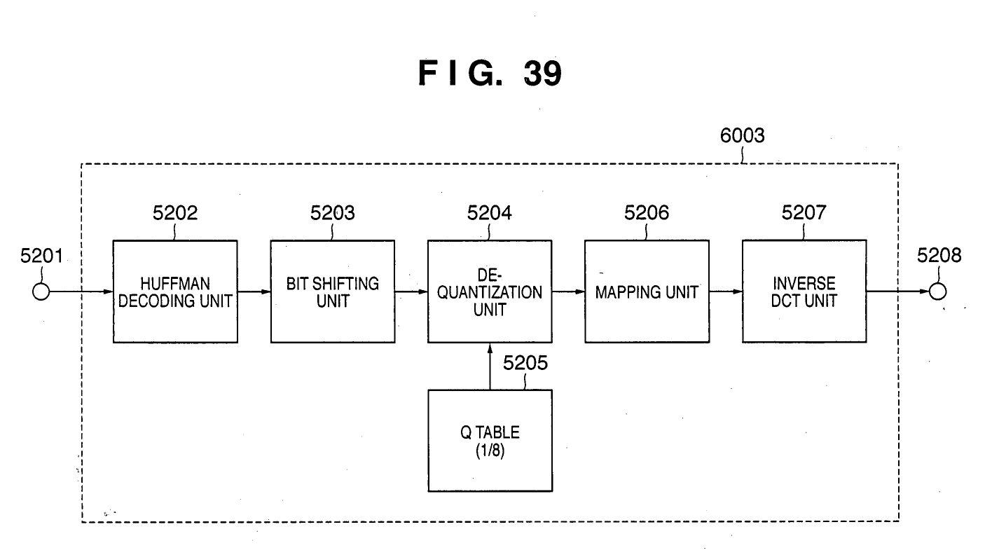

FIG. 39 is a block diagram showing the arrangement of the JPEG decompression unit of a tile decompression unit 1 (2113) according to the second embodiment. A Huffman decoding unit 5202 decodes the pixel data input from an input terminal 5201, which is Huffman-coded data. A bit shifting unit 5203 receives, from the RAM controller 2124, information indicating the number of times bit shifting was performed in JPEG coding, and outputs the received value to a de-quantization unit 5204 without any change when the information indicates 0. If the information indicates 1, the bit shifting unit 5203 shifts the data to the left by one bit to increase its value by two times. If the information indicates 2, the bit shifting unit 5203 shifts the data to the left by two bits to increase its value by four times. If the information indicates 3, the bit shifting unit 5203 shifts the data to the left by three bits to increase its value by eight times. The de-quantization unit 5204 de-quantizes the data by using a quantization table 5205 for decoding which is based on a quantization table of a predictive compression ratio (1/8 in this embodiment) used for coding operation. A mapping unit 5206 maps the one-dimensional continuous data obtained by zigzag-scanning the DCT coefficients into two-dimensional data again. An inverse DCT unit 5207 decodes the data by performing inverse discrete cosine transform for each 8×8 area, and outputs the decoded data from an output terminal 5208.

The above processing makes it possible to detect in real time that data compressed by JPEG is to be stored beyond the memory capacity, and to switch processes in the system such that the image data is compressed at a higher compression ratio to allow all the compressed data to be stored in the memory. In addition, counting the number of times of bit shifting in JPEG coding by using the counter of the RAM controller and setting the count information as the number of times of bit shifting in JPEG decoding allows JPEG decoding without having a plurality of quantization tables.

[Third Embodiment]

In the first embodiment, the counter 1509 of the tile compression unit 1 (2106) counts the number of times Ram Rst flag 3022 is set to “1”, and the count value is stored in a register of the tile compression unit 1 (2106) or the like, thereby setting a quantization table for subsequent decoding operation.

In contrast to this, in the third embodiment of the present invention, a counter 1509 of a tile compression unit 1 (2106) counts the number of times Ram Rst flag 3022 is set to “1”, and the count value is written in the header portion of packet data. The data is decoded on the basis of the count value in the header portion. In addition, data can be decoded, without preparing a plurality of quantization tables, in accordance with the number of times a RAM 2002 was reset in coding operation.

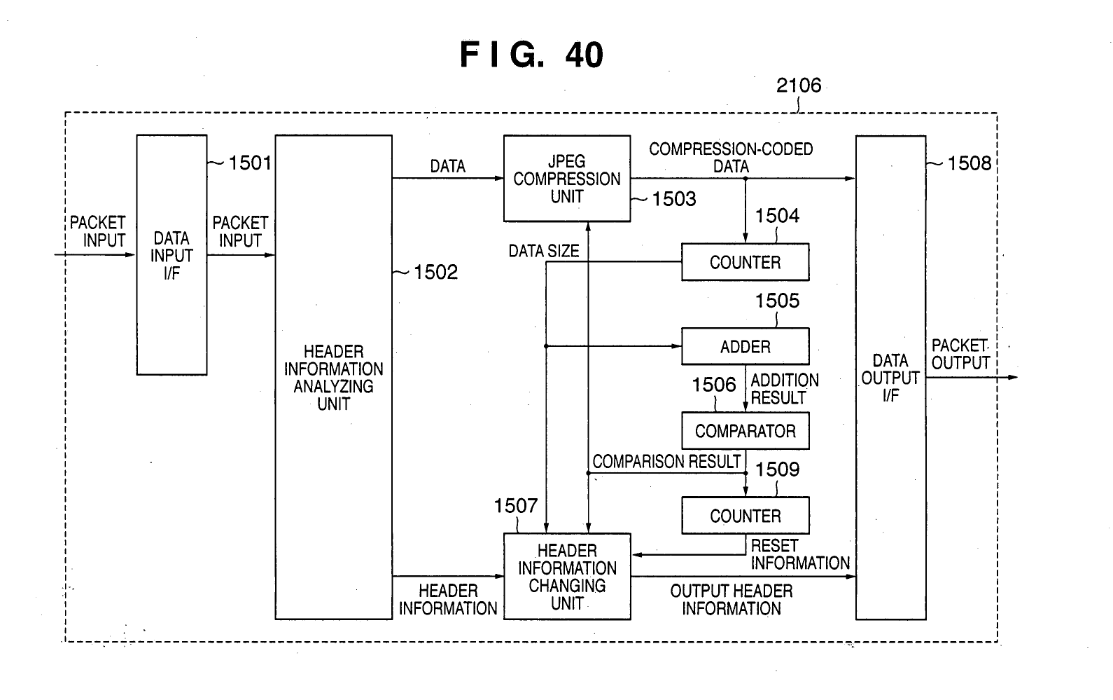

FIG. 40 is a block diagram showing the arrangement of the tile compression unit 1 (2106) according to the third embodiment of the present invention. The same reference numerals as in the arrangement of the tile compression unit 1 (2106) in FIG. 33 denote the same parts in this arrangement. A characteristic feature of the third embodiment is that the count value obtained by the counter 1509 which counts the number of times Ram Rst flag 3022 is set to “1” is input to a header information changing unit 1507. With this arrangement, the number of times the RAM 2002 was reset in compressing packet data is written in the header information of the data to be output.

Reference numeral 1501 denotes a data input interface which receives packeted data from a tile bus 2107; and 1502, a header information analyzing unit which reads the information of the header portion of packet data, and outputs it as header information to a header information changing unit 1507. The information of the header portion is input to a JPEG compression unit 1503 to be compressed by the above method. The data compressed in this manner is output to a data output interface 1508 and is also input to a counter 1504. The counter 1504 counts the data amount of data after compression, and outputs the resultant information as a data size to the header information changing unit 1507 and an adder 1505. The adder 1505 adds the compressed data and outputs the addition result to a comparator 1506. Assume that at this time, addition is performed in consideration of the data amount of the header portion. When the addition result from the adder 1505 exceeds the memory capacity of the RAM 2002, the comparator 1506 outputs a signal informing this to the JPEG compression unit 1503, the header information changing unit 1507, and a counter 1509. At the same time, the value of the adder 1505 is cleared. Upon receiving the signal indicating that the capacity is exceeded, the JPEG compression unit 1503 switches to control operation for creating and outputting data at a higher compression ratio. The counter 1509 counts how many times the signal indicating that the capacity was exceeded was output, and outputs the count value to the header information changing unit 1507. The header information changing unit 1507 changes the data size information in the header portion of packet data to the size after compression, and rewrites the compression flag to set it as a data indication after compression. When the comparison result received from the comparator 1506 exceeds the capacity of the RAM 2002, the corresponding information is set in RAM Rst flag 3022 in the header portion. In addition, the reset count from the counter 1509 is set as output header information in the header. The header information changed in this manner is input to the data output interface 1508 and added as the header of data after compression. The resultant data is then output as packet data to an image ring interface 2102.

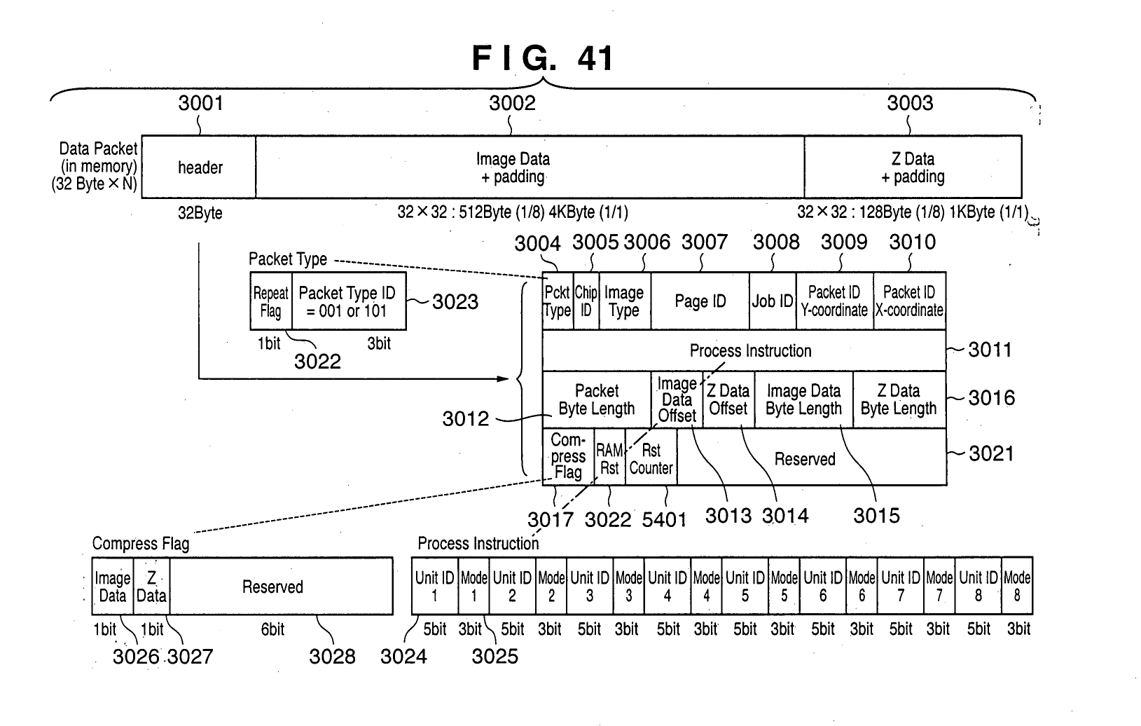

FIG. 41 is a view showing the contents of the header portion of packet data according to the third embodiment of the present invention. This embodiment differs from the preceding embodiments in that Rst Counter 5401 is provided. The count value of the reset count input from the counter 1509 is set in this portion and output to be stored in the RAM 2002. When the JPEG-compressed data output from the RAM 2002 is to be decompressed by a tile decompression unit 1 (2103), the information of Rst Counter 5401 in the header portion is read out to detect how many times bit shifting was performed in JPEG coding. If Rst Counter 5401 is “0”, no bit shifting was performed by using a quantization table corresponding to 1/8. If Rst Counter 5401 is “1”, bit shifting was performed once by using the quantization table corresponding to 1/8. If Rst Counter 5401 is “2”, bit shifting was performed twice by using the quantization table corresponding to 1/8. A JPEG decompression unit 6003 decodes the JPEG data on the basis of this information.

Assume that the arrangement for decoding JPEG-compressed data in this embodiment is the same as that of the JPEG decompression unit 1703 of the tile decompression unit 1 (2113) in the second embodiment (FIG. 39).

A Huffman decoding unit 5202 decodes the pixel data input from an input terminal 5201. A bit shifting unit 5203 receives information indicating the number of times of bit shifting in JPEG coding from Rst Counter 5401 of the header information, and outputs the data to a de-quantization unit 5204 without any change if Rst Counter 5401 indicates 0. If Rst Counter 5401 indicates 1, the bit shifting unit 5203 shifts the data to the left by one bit to increase its value by two times, and outputs the resultant data. If Rst Counter 5401 indicates 2, the bit shifting unit 5203 shifts the data to the left by two its to increase its value by four times, and output the resultant data. If Rst Counter 5401 indicates 3, the bit shifting unit 5203 shifts the data to the left by three bits to increase its value by eight times, and outputs the resultant value.

The de-quantization unit 5204 de-quantizes the data by using a quantization table 5505 for decoding which is based on a quantization table of a predictive compression ratio (1/8 in this embodiment) used for coding operation. A mapping unit 5206 maps the one-dimensional continuous data obtained by zigzag-scanning the DCT coefficients into two-dimensional data again. An inverse DCT unit 5207 decodes the data by performing inverse discrete cosine transform for each 8×8 area, and outputs the decoded data from an output terminal 5208.

The above processing makes it possible to detect in real time that data compressed by JPEG is to be stored beyond the memory capacity, and to switch processes in the system such that the image data is compressed at a higher compression ratio to allow all the compressed data to be stored in the memory. In addition, counting the number of times of bit shifting in JPEG coding by using Rst Counter 5401 of the header information and setting the count information as the number of times of bit shifting in JPEG decoding allows JPEG decoding without having a plurality of quantization tables.

[Other Embodiment]

As described above, according to this embodiment, when JPEG-compressed data is to be stored beyond the memory capacity, this operation is detected in real time, and the compression ratio is changed such that the data is compressed, at a higher compression ratio by bit shifting, into a data amount falling within the memory capacity. The coded data compressed and stored in this manner can be decoded by setting a quantization table corresponding to a quantization table used in coding operation.

Note that the embodiments of the present invention can be expressed in the following forms.

[First Form]

An image processing apparatus comprising:

a compression unit which compresses image data;

a data amount calculation unit which obtains a data amount of the image data compressed by said compression unit;

a determination unit which determines whether the data amount calculated by said data amount calculation unit exceeds a capacity of a memory;

a control unit which performs control to increase a compression ratio of said compression unit in accordance with a determination result obtained by said determination unit, make said compression unit compress the image data, and store the image data in the memory;

a counting unit which counts the number of times said determination unit determined that the data amount exceeded the capacity of the memory;

a holding unit which holds the counted number of times; and

a decoding unit which decodes the data stored in the memory on the basis of the number of times held by said holding unit.

[Second Form]

The apparatus according to First Form, wherein said compression unit comprises

an orthogonal transform unit which orthogonally transforms image data,

a quantization unit which quantizes coefficients orthogonally transformed by said orthogonal transform unit in accordance with a quantization table,

a shift unit which shifts the coefficients quantized by said quantization unit to change the compression ratio, and

a coding unit which codes the coefficients shifted by said shift unit.

[Third Form]

The apparatus according to Second Form, wherein said decoding unit performs decoding upon setting a quantization table corresponding to the held number of times.

[Forth Form]

An image processing method comprising the steps of:

compressing image data;

obtaining a data amount of the image data compressed in the compression step;

determining whether the data amount calculated in the data amount obtaining step exceeds a capacity of a memory;

performing control to increase a compression ratio of the compression step in accordance with a determination result obtained in the determination step, compress the image data in the compression step, and store the image data in the memory;

counting the number of times determined in the determination step that the data amount exceeded the capacity of the memory;

holding the counted number of times; and

decoding the data stored in the memory on the basis of the number of times held in holding step.

[Fifth Form]

The method according to Forth Form, wherein the compression step comprises the steps of

orthogonally transforming image data,

quantizing coefficients orthogonally transformed in the orthogonal transform step in accordance with a quantization table,

shifting the coefficients quantized in the quantization step to change the compression ratio, and

coding the coefficients shifted in the shift step.

[Sixth Form]

The method according to Fifth Form, wherein in the decoding step, decoding is performed upon setting a quantization table corresponding to the held number of times.

Note that the present invention can be applied to an apparatus comprising a single device or to system constituted by a plurality of devices.

Furthermore, the invention can be implemented by supplying a software program, which implements the functions of the foregoing embodiments, directly or indirectly to a system or apparatus, reading the supplied program code with a computer of the system or apparatus, and then executing the program code. In this case, so long as the system or apparatus has the functions of the program, the mode of implementation need not rely upon a program.

Accordingly, since the functions of the present invention are implemented by computer, the program code itself installed in the computer also implements the present invention. In other words, the claims of the present invention also cover a computer program for the purpose of implementing the functions of the present invention.

In this case, so long as the system or apparatus has the functions of the program, the program may be executed in any form, e.g., as object code, a program executed by an interpreter, or scrip data supplied to an operating system.

Example of storage media that can be used for supplying the program are a floppy disk, a hard disk, an optical disk, a magneto-optical disk, a CD-ROM, a CD-R, a CD-RW, a magnetic tape, a non-volatile type memory card, a ROM, and a DVD (DVD-ROM and a DVD-R).

As for the method of supplying the program, a client computer can be connected to a website on the Internet using a browser of the client computer, and the computer program of the present invention or an automatically-installable compressed file of the program can be downloaded to a recording medium such as a hard disk. Further, the program of the present invention can be supplied by dividing the program code constituting the program into a plurality of files and downloading the files from different websites. In other words, a WWW (World Wide Web) server that downloads, to multiple users, the program files that implement the functions of the present invention by computer is also covered by the claims of the present invention.

Further, it is also possible to encrypt and store the program of the present invention on a storage medium such as a CD-ROM, distribute the storage medium to users, allow users who meet certain requirements to download decryption key information from a website via the Internet, and allow these users to decrypt the encrypted program by using the key information, whereby the program is installed in the user computer.

Furthermore, besides the case where the aforesaid functions according to the embodiments are implemented by executing the read program by computer, an operating system or the like running on the computer may perform all or a part of the actual processing so that the functions of the foregoing embodiments can be implemented by this processing.

Furthermore, after the program read from the storage medium is written to a function expansion board inserted into the computer or to a memory provided in a function expansion unit connected to the computer, a CPU or the like mounted on the function expansion board or function expansion unit performs all or a part of the actual processing so that the functions of the foregoing embodiments can be implemented by this processing.

As many apparently widely different embodiments of the present invention can be made without departing from the spirit and scope thereof, it is to be understood that the invention is not limited to the specific embodiments thereof except as defined in the appended claims.

What is claimed is:

1. An image processing apparatus comprising:
a compression unit which compresses image data;
a data amount calculation unit which obtains a data amount of the image data compressed by said compression unit;
a determination unit which determines whether the data amount calculated by said data amount calculation unit exceeds a capacity of a memory;
a control unit which performs control to increase a compression ratio of said compression unit in accordance with a determination result obtained by said determination unit, make said compression unit compress the image data, and store the image data in the memory;
a counting unit which counts the number of times said determination unit determined that the data amount exceeded the capacity of the memory;
a holding unit which holds the counted number of times; and
a decoding unit which decodes the data stored in the memory on the basis of the number of times held by said holding unit.

2. The apparatus according to claim 1, wherein said compression unit comprises
an orthogonal transform unit which orthogonally transforms image data,
a quantization unit which quantizes coefficients orthogonally transformed by said orthogonal transform unit in accordance with a quantization table,
a shift unit which shifts the coefficients quantized by said quantization unit to change the compression ratio, and
a coding unit which codes the coefficients shifted by said shift unit.

3. The apparatus according to claim 2, wherein said decoding unit performs decoding upon setting a quantization table corresponding to the held number of times.

4. An image processing method comprising the steps of:
compressing image data;
obtaining a data amount of the image data compressed in the compression step;
determining whether the data amount calculated in the data amount obtaining step exceeds a capacity of a memory;
performing control to increase a compression ratio of the compression step in accordance with a determination result obtained in the determination step, compress the image data in the compression step, and store the image data in the memory;
counting the number of times determined in the determination step that the data amount exceeded the capacity of the memory;
holding the counted number of times; and
decoding the data stored in the memory on the basis of the number of times held in holding step.

5. The method according to claim 4, wherein the compression step comprises the steps of
orthogonally transforming image data,
quantizing coefficients orthogonally transformed in the orthogonal transform step in accordance with a quantization table,
shifting the coefficients quantized in the quantization step to change the compression ratio, and
coding the coefficients shifted in the shift step.

6. The method according to claim 5, wherein in the decoding step, decoding is performed upon setting a quantization table corresponding to the held number of times.

7. An image processing apparatus comprising:
a compression unit which compresses image data;
a data amount calculation unit which obtains a data amount of the image data compressed by said compression unit;
a determination unit which determines whether the data amount calculated by said data amount calculation unit exceeds a capacity of a memory;
a control unit which performs control to increase a compression ratio of said compression unit in accordance with a determination result obtained by said determination unit, make said compression unit compress the image data, and store the image data in the memory;
a counting unit which counts the number of times said determination unit determined that the data amount exceeded the capacity of the memory; and
a holding unit which holds the counted number of times to decode the data stored in the memory.

8. The apparatus according to claim 7, wherein said holding unit holds the number of times to determine a quantization table to be used to decode the data stored in the memory.

9. An image processing method comprising the steps of:
compressing image data;
obtaining a data amount of the image data compressed in the compression step;
determining whether the data amount calculated in the data amount obtaining step exceeds a capacity of a memory;
performing control to increase a compression ratio of the compression step in accordance with a determination result obtained in the determination step, compress the image data in the compression step, and store the image data in the memory;
counting the number of times determined in the determination step that the data amount exceeded the capacity of the memory; and
holding the counted number of times to decode the data stored in the memory.

10. The method according to claim 9, wherein in the holding step, the number of times is held to determine a quantization table to be used to decode the data stored in the memory.

11. An image processing apparatus which, on a coding side for image data, obtains a data amount of compressed image data, determines whether the obtained data amount exceeds a capacity of a memory, increases a compression ratio in the compression in accordance with the determination, compresses the image data, and decodes the compressed image data stored in the memory, comprising:
a holding unit which holds the number of times it was determined that the data amount exceeded the capacity of the memory in coding operation on the coding side; and
a decoding unit which decodes the data stored in the memory in accordance with the number of times stored in said holding unit.

12. The apparatus according to claim 11, wherein said holding unit holds the number of times to determine a quantization table to be used to decode the data stored in the memory.

13. An image processing method which, on a coding side for image data, obtains a data amount of compressed image data, determines whether the obtained data amount exceeds a capacity of a memory, increases a compression ratio in the compression in accordance with the determination, compresses the image data, and decodes the compressed image data stored in the memory, comprising:
a holding step of holding the number of times it was determined that the data amount exceeded the capacity of the memory in coding operation on the coding side; and
a decoding step of decoding the data stored in the memory in accordance with the number of times stored in the holding step.

14. The method according to claim 13, wherein in the holding step, the number of times is held to determine a quantization table to be used to decode the data stored in the memory.
